(19) United States
(12) Patent Application Publication
(10) Pub. No.: US 2025/0309796 A1
(43) Pub. Date: Oct. 2, 2025

(54) MOTOR DRIVE DEVICE, MOTOR SYSTEM AND VEHICLE

(71) Applicant: ROHM CO., LTD., Kyoto-shi (JP)

(72) Inventor: Hirotaka TAKIHARA, Kyoto-shi (JP)

(21) Appl. No.: 19/236,229

(22) Filed: Jun. 12, 2025

Related U.S. Application Data
(63) Continuation of application No. PCT/JP2023/043486, filed on Dec. 5, 2023.

(30) Foreign Application Priority Data
Dec. 19, 2022 (JP) 2022-201952

(51) Int. Cl. H02P 6/08; H02H 7/08; H02K 7/14; H02K 19/10

(52) U.S. Cl. CPC H02P 6/085; H02H 7/0805; H02H 7/0833; H02K 7/14; H02K 19/10

(57) ABSTRACT

A motor drive device includes: a check performance unit configured to perform an abnormality check operation for at least one of an upper transistor, a lower transistor and a motor in a state where a second main electrode is pulled up or pulled down by bringing one of a second main electrode pull-down switch and a second main electrode pull-up switch into an on state; and a control circuit configured to control a combination of on/off states of the upper transistor, the lower transistor and a motor relay connected to the motor.

### CROSS REFERENCE TO RELATED APPLICATIONS

This application is a continuation under 35 U.S.C. § 120 of PCT/JP2023/043486 filed on Dec. 5, 2023, which claims priority Japanese Patent Application No. 2022-201952 filed on Dec. 19, 2022. The present application likewise claims priority under 35 U.S.C. § 119 to Japanese Application No. 2022-201952, filed Dec. 19, 2022, the entire content of which is also incorporated herein by reference.

### TECHNICAL FIELD

The present disclosure relates to motor drive devices.

### BACKGROUND ART

Conventionally, brushless DC (direct-current) motors are installed in various devices. The brushless DC motor does not have a current transfer mechanism using a brush, and thus it is necessary to switch the direction of a current supplied to a coil according to the position of a rotor. A three-phase brushless DC motor is driven by a motor drive device which includes half-bridges corresponding to a U phase, a V phase and a W phase (for example, Patent Document 1).

### RELATED ART DOCUMENT

### Patent Document

Patent Document 1: Japanese Unexamined Patent Application Publication No. 2021-40404

### BRIEF DESCRIPTION OF DRAWINGS

FIG. 1 is a diagram showing the configuration of a motor system according to an illustrative embodiment of the present disclosure;

FIG. 2 is a diagram showing an example of the internal configuration of a motor drive device;

FIG. 3 is a diagram hierarchically showing the order of priority of various checks;

FIG. 4 is a table showing the order of check contents in check operations performed at startup;

FIG. 5 is a diagram showing the operation state of the motor system during short circuit checks of power supply relays;

FIG. 6 is a diagram showing a current which flows normally during the short circuit checks of the power supply relays;

FIG. 7 is a diagram showing the operation state of the motor system during open circuit checks of the power supply relays;

FIG. 8 is a diagram showing the operation state of the motor system during a short circuit check of a first upper transistor;

FIG. 9 is a diagram showing the operation state of the motor system during a short circuit check of a first lower transistor;

FIG. 10 is a diagram showing the operation state of the motor system during a short circuit check of a second upper transistor;

FIG. 11 is a diagram showing the operation state of the motor system during a short circuit check of a second lower transistor;

FIG. 12 is a diagram showing the operation state of the motor system during a short circuit check of a third upper transistor;

FIG. 13 is a diagram showing the operation state of the motor system during a short circuit check of a third lower transistor;

FIG. 14 is a diagram showing the operation state of the motor system during an open circuit check of the first upper transistor;

FIG. 15 is a diagram showing the operation state of the motor system during an open circuit check of the first lower transistor;

FIG. 16 is a diagram showing the operation state of the motor system during an open circuit check of the second upper transistor;

FIG. 17 is a diagram showing the operation state of the motor system during an open circuit check of the second lower transistor;

FIG. 18 is a diagram showing the operation state of the motor system during an open circuit check of the third upper transistor;

FIG. 19 is a diagram showing the operation state of the motor system during an open circuit check of the third lower transistor;

FIG. 20 is a diagram showing the operation state of the motor system during a short-to-power check of a motor;

FIG. 21 is a diagram showing the operation state of the motor system during a ground fault check of the motor;

FIG. 22 is a diagram showing the operation state of the motor system during a short circuit check of a first motor relay;

FIG. 23 is a diagram showing the operation state of the motor system during a short circuit check of a second motor relay;

FIG. 24 is a diagram showing the operation state of the motor system during a short circuit check of a third motor relay;

FIG. 25 is a diagram showing the operation state of the motor system during an open circuit check of the first motor relay;

FIG. 26 is a diagram showing the operation state of the motor system during an open circuit check of the second motor relay;

FIG. 27 is a diagram showing the operation state of the motor system during an open circuit check of the third motor relay; and

FIG. 28 is an external view showing an example of the configuration of a vehicle which incorporates the motor system.

### DESCRIPTION OF EMBODIMENTS

An illustrative embodiment of the present disclosure will be described below with reference to drawings.

### <1. Configuration of Motor System>

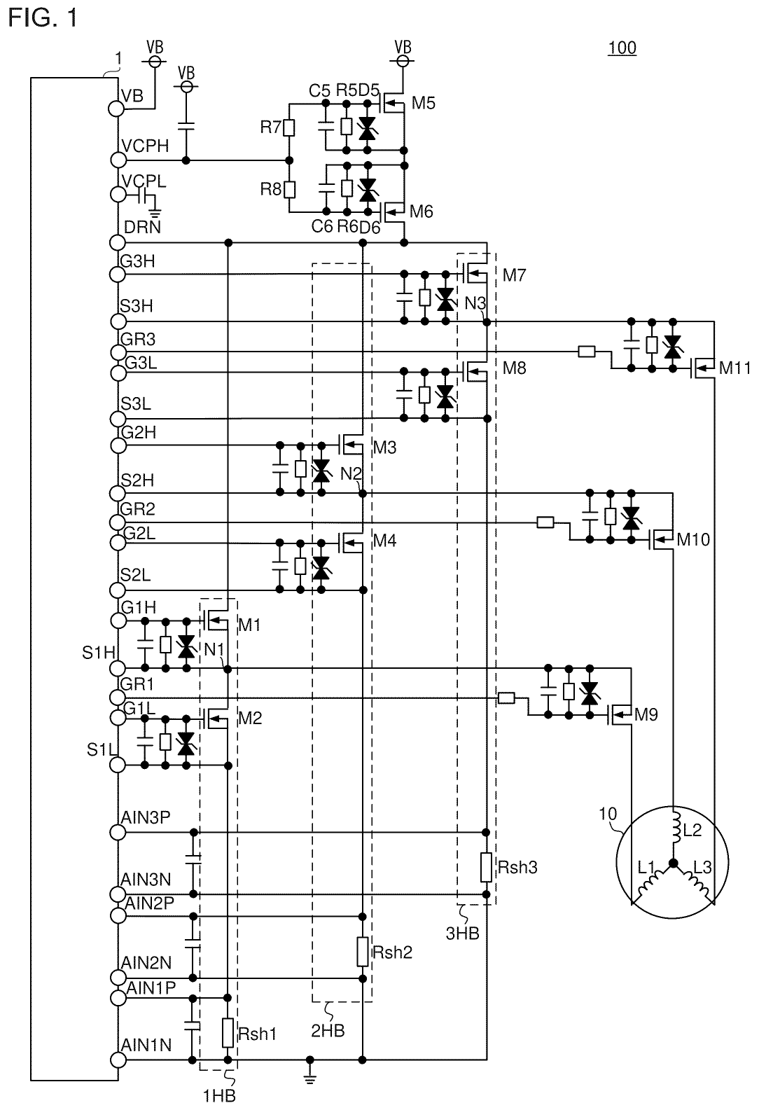

FIG. 1 is a diagram showing the configuration of a motor system 100 according to the illustrative embodiment of the present disclosure. The motor system 100 shown in FIG. 1 includes a motor drive device 1 and a brushless DC motor (hereinafter simply referred to as the motor) 10. The motor drive device 1 is configured to drive the motor 10 of three phases (a U phase, a V phase and a W phase).

The motor drive device 1 is a semiconductor device obtained by integrating an internal configuration which will be described later. The motor drive device 1 includes, as external terminals for establishing electrical connection to the outside, a VB terminal (power supply terminal), a VCPH terminal (charge pump output terminal), a VCPL terminal (charge pump output terminal), a DRN terminal (drain terminal), a G3H terminal (third upper gate output terminal), an S3H terminal (third upper source terminal), a GR3 terminal (third relay gate terminal), a G3L terminal (third lower gate output terminal) and an S3L terminal (third lower source terminal).

The motor drive device 1 also includes, as external terminals, a G2H terminal (second upper gate output terminal), an S2H terminal (second upper source terminal), a GR2 terminal (second relay gate terminal), a G2L terminal (second lower gate output terminal) and an S2L terminal (second lower source terminal).

The motor drive device 1 also includes, as external terminals, a G1H terminal (first upper gate output terminal), an S1H terminal (first upper source terminal), a GR1 terminal (first relay gate terminal), a GIL terminal (first lower gate output terminal) and an SIL terminal (first lower source terminal).

The motor drive device 1 also includes, as external terminals, an AIN3P terminal (third current sense positive input terminal), an AIN3N terminal (third current sense negative input terminal), an AIN2P terminal (second current sense positive input terminal), an AIN2N terminal (second current sense negative input terminal), an AIN1P terminal (first current sense positive input terminal) and an AIN1N terminal (first current sense negative input terminal).

The motor system 100 includes a first half-bridge 1HB corresponding to the U phase of the motor 10, a second half-bridge 2HB corresponding to the V phase of the motor 10 and a third half-bridge 3HB corresponding to the W phase of the motor 10. The first, second and third half-bridges 1HB, 2HB and 3HB are arranged outside the motor drive device 1.

The first half-bridge 1HB includes a first upper transistor (U-phase upper transistor) M1, a first lower transistor (U-phase lower transistor) M2 and a first shunt resistor Rsh1. Each of the first upper transistor M1 and the first lower transistor M2 is formed with an N-channel MOSFET (metal-oxide-semiconductor field-effect transistor). The drain of the first upper transistor M1 is connected to the DRN terminal. The source of the first upper transistor M1 is connected to the drain of the first lower transistor M2. The source of the first lower transistor M2 is connected to one end of the first shunt resistor Rsh1. The other end of the first shunt resistor Rsh1 is connected to the application end of a ground potential.

The second half-bridge 2HB includes a second upper transistor (V-phase upper transistor) M3, a second lower transistor (V-phase lower transistor) M4 and a second shunt resistor Rsh2. Each of the second upper transistor M3 and the second lower transistor M4 is formed with an N-channel MOSFET. The drain of the second upper transistor M3 is connected to the DRN terminal. The source of the second upper transistor M3 is connected to the drain of the second lower transistor M4. The source of the second lower transistor M4 is connected to one end of the second shunt resistor Rsh2. The other end of the second shunt resistor Rsh2 is connected to the application end of the ground potential.

The third half-bridge 3HB includes a third upper transistor (W-phase upper transistor) M7, a third lower transistor (W-phase lower transistor) M8 and a third shunt resistor Rsh3. Each of the third upper transistor M7 and the third lower transistor M8 is formed with an N-channel MOSFET. The drain of the third upper transistor M7 is connected to the DRN terminal. The source of the third upper transistor M7 is connected to the drain of the third lower transistor M8. The source of the third lower transistor M8 is connected to one end of the third shunt resistor Rsh3. The other end of the third shunt resistor Rsh3 is connected to the application end of the ground potential.

Each of the shunt resistors Rsh1, Rsh2 and Rsh3 is a current detection unit which is configured to convert a current into a voltage signal to detect the current.

The motor 10 includes a stator which includes a first coil L1 of the U phase, a second coil L2 of the V phase and a third coil L3 of the W phase. The motor 10 includes a rotor (not shown) which is configured to include a magnet and to be rotatable relative to the stator.

The motor system 100 includes a first motor relay M9 corresponding to the U phase, a second motor relay M10 corresponding to the V phase and a third motor relay M11 corresponding to the W phase. Each of the motor relays M9, M10 and M11 is a switch which is arranged outside the motor drive device 1 and switches between the supply and blockage of a current to the motor 10. Each of the motor relays M9, M10 and M11 is formed with an N-channel MOSFET.

A first node N1 to which the source of the first upper transistor M1 and the drain of the first lower transistor M2 are connected is connected to the source of the first motor relay M9. The drain of the first motor relay M9 is connected to one end of the first coil L1. A second node N2 to which the source of the second upper transistor M3 and the drain of the second lower transistor M4 are connected is connected to the source of the second motor relay M10. The drain of the second motor relay M10 is connected to one end of the second coil L2. A third node N3 to which the source of the third upper transistor M7 and the drain of the third lower transistor M8 are connected is connected to the source of the third motor relay M11. The drain of the third motor relay M11 is connected to one end of the third coil L3. The other ends of the coils L1, L2 and L3 are connected together. In this way, in the motor 10, so-called star wiring is formed.

The motor system 100 includes a first power supply relay M5 and a second power supply relay M6. The power supply relays M5 and M6 are arranged outside the motor drive device 1. Each of the power supply relays M5 and M6 is formed with an N-channel MOSFET, and is a switch for switching between the supply and blockage of a battery voltage VB to half-bridges HB1, HB2 and HB3. The drain of the first power supply relay M5 is connected to the application end of the battery voltage VB. The source of the first power supply relay M5 is connected to the source of the second power supply relay M6. The drain of the second power supply relay M6 is connected to the drains of the upper transistors M1, M3 and M7.

The motor system 100 includes first resistors R7 and R8, capacitors C5 and C6, second resistors R5 and R6 and diodes D5 and D6, and these constituent components are arranged outside the motor drive device 1.

The VCPH terminal is connected to one end of the first resistors R7 and R8. The other ends of the first resistors R7 and R8 are connected to the gates of the power supply relays M5 and M6. The capacitors C5 and C6, the second resistors R5 and R6 and the diodes D5 and D6 are connected between the gate and the source of the power supply relay M5 and between the gate and the source of the power supply relay M6.

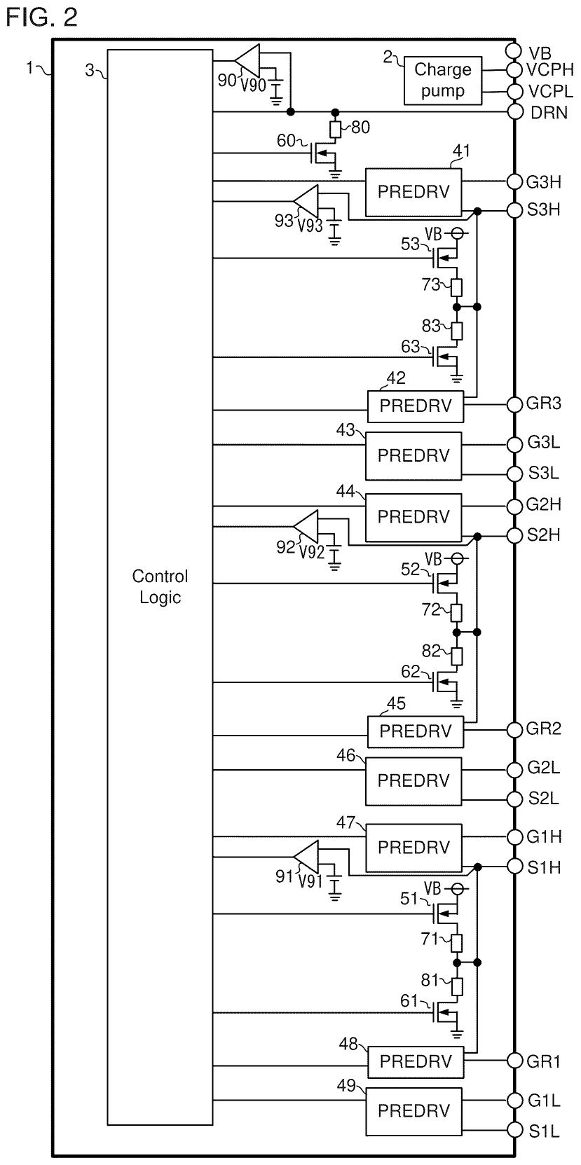

As shown in FIG. 2 which will be described later, the motor drive device 1 includes a charge pump 2. The charge pump 2 steps up the battery voltage VB applied to the VB terminal to generate a charge pump output voltage VCPH. The charge pump output voltage VCPH is output from the VCPH terminal and is applied to the one end of the first resistors R7 and R8. When the charge pump 2 is in an on state, the power supply relays M5 and M6 are in on state due to the charge pump output voltage VCPH, and the battery voltage VB is applied to the drains of the upper transistors M1, M3 and M7. On the other hand, when the charge pump 2 is in an off state, the power supply relays M5 and M6 are in off state. In this case, In this case, a bidirectional current is blocked by the body diodes of the power supply relays M5 and M6.

A pre-driver and an external terminal for a drive signal output from the pre-driver may be provided in the motor drive device 1 according to the power supply relays M5 and M6, and the gates of the power supply relays M5 and M6 may be driven based on the drive signal output from the external terminal. However, as in the configuration shown in FIG. 1, the VCPH terminal is used to drive the power supply relays M5 and M6, and thus it is possible to reduce the number of external terminals.

The capacitors C5 and C6 are provided for noise suppression. The second resistors R5 and R6 are provided such that when the power supply relays M5 and M6 are in an off state, gate-source voltages are prevented from being unstable. The diodes D5 and D6 are provided for surge protection. Each of the second resistors R5 and R6 has a high resistance value to suppress influences when the power supply relays M5 and M6 are in an on state.

As shown in FIG. 1, the upper transistors M1, M3 and M7, the lower transistors M2, M4 and M8 and capacitors, resistors and diodes connected between the gates and the sources of the motor relays M9, M10 and M11 are provided for the same purposes as the capacitors C5 and C6, the second resistors R5 and R6 and the diodes D5 and D6.

A voltage across the first shunt resistor Rsh1 is input between the AIN1P terminal and the AIN1N terminal. A voltage across the second shunt resistor Rsh2 is input between the AIN2P terminal and the AIN2N terminal. A voltage across the third shunt resistor Rsh3 is input between the AIN3P terminal and the AIN3N terminal.

### <2. Internal Configuration of Motor Drive Device>

FIG. 2 is a diagram showing the internal configuration of the motor drive device 1. As shown in FIG. 2, the motor drive device 1 includes the charge pump 2, a control logic unit 3, pre-drivers 41 to 49, pull-up switches 51 to 53, pull-down switches 60 to 63, pull-up resistors 71 to 73, pull-down resistors 80 to 83 and comparators 90 to 93.

The charge pump 2 outputs a charge pump output voltage VCPH for turning on the power supply relays M5 and M6 as described above, as well as turning on the upper transistors M1, M3, and M7 and the motor relays M9, M10, and M11. The charge pump output voltage VCPH is supplied to the pre-drivers 41, 42, 44, 45, 47 and 48. The charge pump 2 also generates a charge pump output voltage VCPL (<VCPH) for bringing the lower transistors M2, M4 and M8 into an on state. The charge pump output voltage VCPL is supplied to the pre-drivers 43, 46 and 49.

The control logic unit 3 controls units in the motor system 100. In particular, in the present embodiment, the control logic unit 3 performs control for check operations which will be described later.

The pre-driver 41 controls, based on a drive signal from the control logic unit 3, a voltage between the G3H terminal and the S3H terminal, that is, a voltage between the gate and the source of the third upper transistor M7, and thereby controls the turning on and off of the third upper transistor M7.

The pre-driver 42 outputs, based on a drive signal from the control logic unit 3, a gate signal from the GR3 terminal to the gate of the third motor relay M11, and thereby controls the turning on and off of the third motor relay M11.

The pre-driver 43 controls, based on a drive signal from the control logic unit 3, a voltage between the G3L terminal and the S3L terminal, that is, a voltage between the gate and the source of the third lower transistor M8, and thereby controls the turning on and off of the third lower transistor M8.

The pre-driver 44 controls, based on a drive signal from the control logic unit 3, a voltage between the G2H terminal and the S2H terminal, that is, a voltage between the gate and the source of the second upper transistor M3, and thereby controls the turning on and off of the second upper transistor M3.

The pre-driver 45 outputs, based on a drive signal from the control logic unit 3, a gate signal from the GR2 terminal to the gate of the second motor relay M10, and thereby controls the turning on and off of the second motor relay M10.

The pre-driver 46 controls, based on a drive signal from the control logic unit 3, a voltage between the G2L terminal and the S2L terminal, that is, a voltage between the gate and the source of the second lower transistor M4, and thereby controls the turning on and off of the second lower transistor M4.

The pre-driver 47 controls, based on a drive signal from the control logic unit 3, a voltage between the G1H terminal and the S1H terminal, that is, a voltage between the gate and the source of the first upper transistor M1, and thereby controls the turning on and off of the first upper transistor M1.

The pre-driver 48 outputs, based on a drive signal from the control logic unit 3, a gate signal from the GR1 terminal to the gate of the first motor relay M9, and thereby controls the turning on and off of the first motor relay M9.

The pre-driver 49 controls, based on a drive signal from the control logic unit 3, a voltage between the GIL terminal and the SIL terminal, that is, a voltage between the gate and the source of the first lower transistor M2, and thereby controls the turning on and off of the first lower transistor M2.

The pull-up switches 51 to 53, the pull-down switches 61 to 63, the pull-up resistors 71 to 73 and the pull-down resistors 81 to 83 are provided for the check operations which will be described later.

Each of the pull-up switches 51 to 53 is formed with an N-channel MOSFET. The source of the first pull-up switch 51 is connected to the application end of the battery voltage VB. The drain of the first pull-up switch 51 is connected to one end of the first pull-up resistor 71. The other end of the first pull-up resistor 71 is connected to the S1H terminal. In this way, the first pull-up switch 51 and the first pull-up resistor 71 can pull up the source of the first upper transistor M1.

Each of the pull-down switches 61 to 63 is formed with an N-channel MOSFET. The source of the first pull-down switch 61 is connected to the application end of the ground potential. The drain of the first pull-down switch 61 is connected to one end of the first pull-down resistor 81. The other end of the first pull-down resistor 81 is connected to the S1H terminal. In this way, the first pull-down switch 61 and the first pull-down resistor 81 can pull down the source of the first upper transistor M1.

The control logic unit 3 drives the gates of the first pull-up switch 51 and the first pull-down switch 61 to control the turning on and off of the first pull-up switch 51 and the first pull-down switch 61.

The connection relationship of the second pull-up switch 52, the second pull-down switch 62, the second pull-up resistor 72 and the second pull-down resistor 82 to the S2H terminal is the same as that of the first pull-up switch 51, the first pull-down switch 61, the first pull-up resistor 71 and the first pull-down resistor 81, and thus details thereof are omitted. The second pull-up switch 52 and the second pull-up resistor 72 can pull up the source of the second upper transistor M3, and the second pull-down switch 62 and the second pull-down resistor 82 can pull down the source of the second upper transistor M3. The control logic unit 3 drives the gates of the second pull-up switch 52 and the second pull-down switch 62 to control the turning on and off of the second pull-up switch 52 and the second pull-down switch 62.

The connection relationship of the third pull-up switch 53, the third pull-down switch 63, the third pull-up resistor 73 and the third pull-down resistor 83 to the S3H terminal is the same as that of the first pull-up switch 51, the first pull-down switch 61, the first pull-up resistor 71 and the first pull-down resistor 81, and thus details thereof are omitted. The third pull-up switch 53 and the third pull-up resistor 73 can pull up the source of the third upper transistor M7, and the third pull-down switch 63 and the third pull-down resistor 83 can pull down the source of the third upper transistor M7. The control logic unit 3 drives the gates of the third pull-up switch 53 and the third pull-down switch 63 to control the turning on and off of the third pull-up switch 53 and the third pull-down switch 63.

The comparators 90 to 93 are provided to be used for the check operations which will be described later. The comparator 90 compares a voltage at the DRN terminal with a reference voltage V90, and outputs the result of the comparison to the control logic unit 3. The comparator 91 compares a voltage at the S1H terminal with a reference voltage V91, and outputs the result of the comparison to the control logic unit 3. The comparator 92 compares a voltage at the S2H terminal with a reference voltage V92, and outputs the result of the comparison to the control logic unit 3. The comparator 93 compares a voltage at the S3H terminal with a reference voltage V93, and outputs the result of the comparison to the control logic unit 3.

### <Check Operations>

The check operations which are performed in the motor system 100 will then be described. The check operations are performed at startup of the motor system 100 before the motor 10 is operated. Specifically, it is possible to check for abnormalities in the upper transistors M1, M3 and M7, the lower transistors M2, M4 and M8, the power supply relays M5 and M6, the motor relays M9, M10 and M11 and the motor 10.

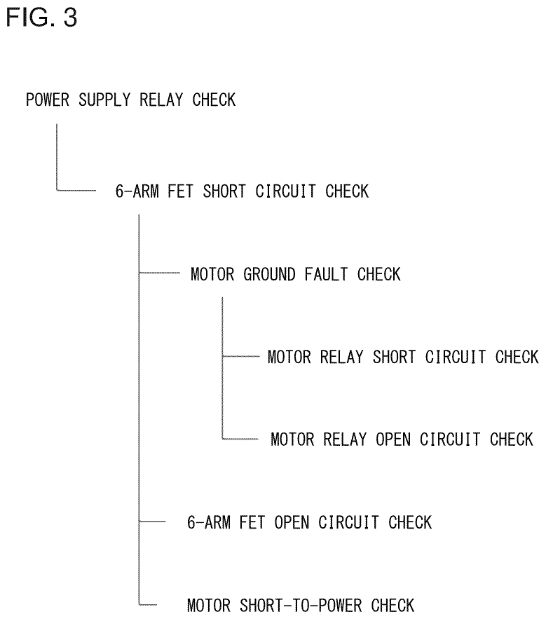

FIG. 3 is a diagram hierarchically showing the order of priority of various checks. The higher the level shown in FIG. 3, the higher the priority of the check. Specifically, short circuit/open circuit checks of the power supply relays M5 and M6 are located at the topmost level, the short circuit checks of the upper transistors M1, M3 and M7 and the lower transistors M2, M4 and M8 (6-arm FET short circuit checks) are located at a level lower than the level, the ground fault check of the motor 10, the open circuit checks (6-arm FET open circuit checks) of the upper transistors M1, M3 and M7 and the lower transistors M2, M4 and M8 and the short-to-power check of the motor 10 are located at a level lower than the level and the short circuit/open circuit checks of the motor relays M9, M10 and M11 are located at a level lower than the level at which the ground fault check of the motor 10 is located.

The hierarchy shown in FIG. 3 indicates that in order to correctly perform a check at a certain level, it is necessary to first perform a check at a level higher than the certain level. For example, in order to correctly perform the short circuit/open circuit checks of the motor relays M9, M10 and M11, it is necessary to first perform the power supply relay checks, the 6-arm FET short circuit checks and the ground fault check of the motor.

As long as the order of priority of the checks shown in FIG. 3 is observed, all the check contents may be checked or only a part of the check contents may be checked. For example, in order to perform the short circuit/open circuit checks of the motor relays M9, M10 and M11 as described above, it is preferable to perform the power supply relay checks, the 6-arm FET short circuit checks and the ground fault check of the motor, and it is not necessary to perform the 6-arm FET open circuit checks and the short-to-power check of the motor, with the result that it is possible to reduce the check time.

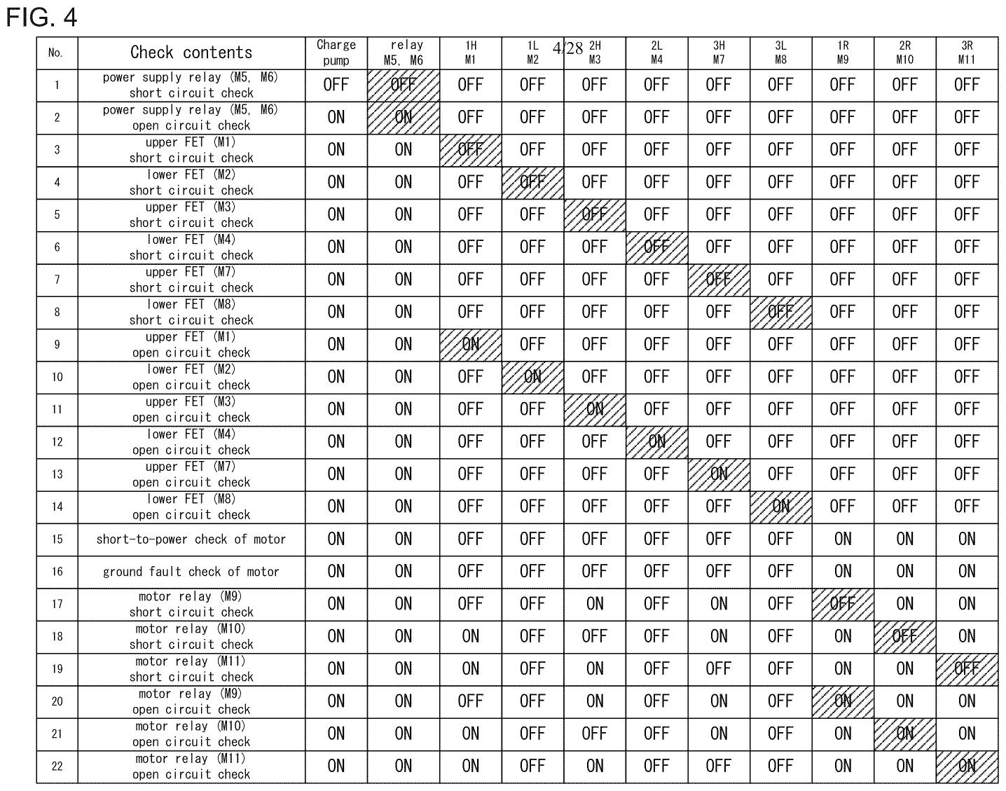

FIG. 4 is a table showing the order of check contents in the check operations performed at startup. In the check contents shown in FIG. 4, all the check contents shown in FIG. 3 are performed. Specifically, the short circuit checks of the power supply relays M5 and M6, the open circuit checks of the power supply relays M5 and M6, the short circuit checks (6-arm FET short circuit checks) of the transistors M1, M2, M3, M4, M7 and M8, the open circuit checks (6-arm FET open circuit checks) of the transistors M1, M2, M3, M4, M7 and M8, the short-to-power check of the motor 10, the ground fault check of the motor 10, the short circuit checks of the motor relays M9, M10 and M11 and the open circuit checks of the motor relays M9, M10 and M11 are performed in this order, and the order of priority shown in FIG. 3 is observed.

In FIG. 4, for each of the check contents, the on and off state of the charge pump 2, the on and off states of the power supply relays M5 and M6, the on and off states of the transistors M1, M2, M3, M4, M7 and M8 and the on and off states of the motor relays M9, M10 and M11 are shown. The hatching in FIG. 4 indicates check targets corresponding to the check contents.

The check operations will be specifically described below for each of the check contents in the order of the checks shown in FIG. 4.

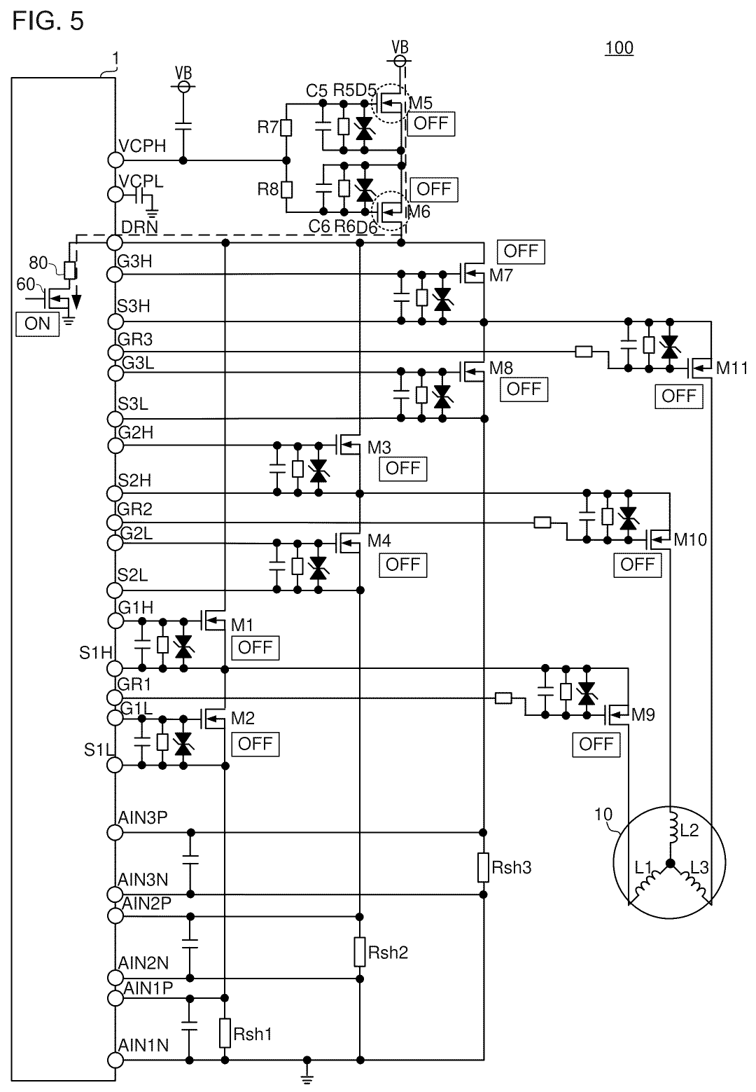

FIG. 5 is a diagram showing the operation state of the motor system 100 during short circuit checks of the power supply relays M5 and M6. In this case, in order to bring the charge pump 2 into an off state, the power supply relays M5 and M6 are in an off state, the transistors M1, M2, M3, M4, M7 and M8 are in an off state and the motor relays M9, M10 and M11 are in an off state. The pull-down switch 60 is brought into an on state to pull down the DRN terminal. In FIG. 5 and the subsequent figures, dotted arrows indicate paths for the check targets, and dotted circles indicate the elements of the check targets.

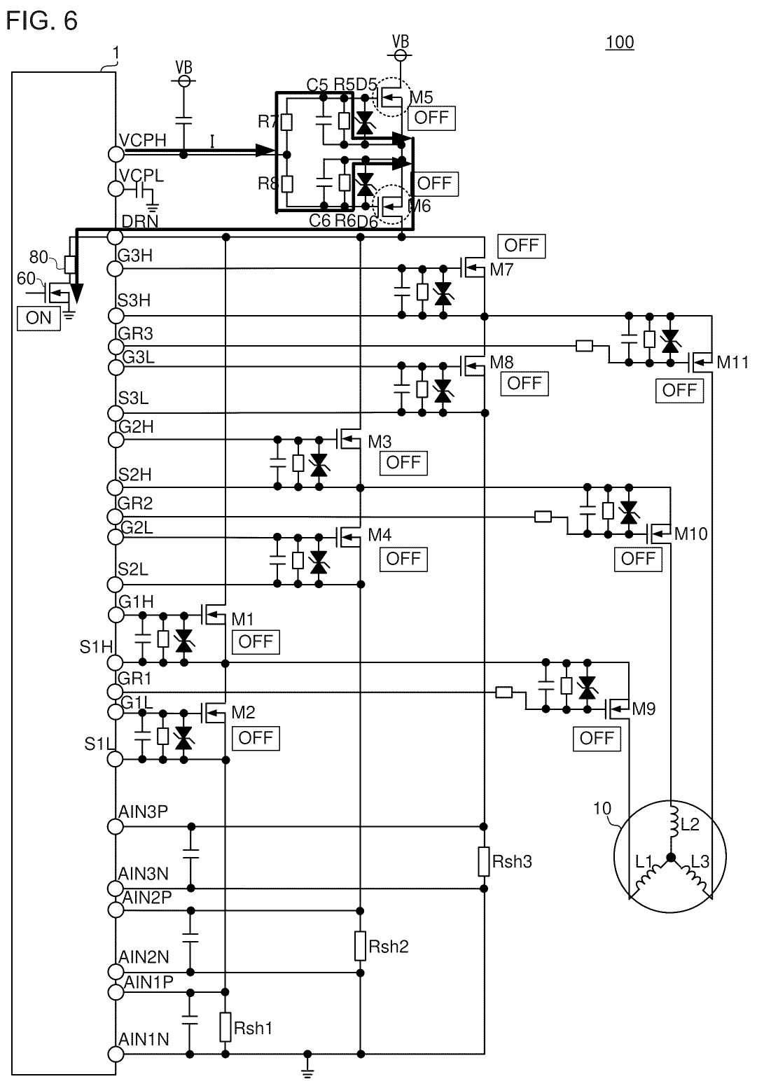

When in the operation state shown in FIG. 5, both the power supply relays M5 and M6 are in an off state during normal conditions, as shown in FIG. 6, a current I flows along a path from the VCPH terminal to the first resistors R7 and R8, to the second resistors R5 and R6, to the body diode of the power supply relay M6, to the DRN terminal, to the pull-down resistor 80 and then to the pull-down switch 60. On the other hand, when a short circuit (leak) occurs in each of the power supply relays M5 and M6, the voltage at the DRN terminal is the battery voltage VB. Hence, when the reference voltage V90 (FIG. 2) for the comparator 90 is set between the voltage at the DRN terminal generated by the current I during normal conditions and the voltage at the DRN terminal during a short circuit, it is possible to perform short circuit checks of the power supply relays M5 and M6 using the output of the comparator 90.

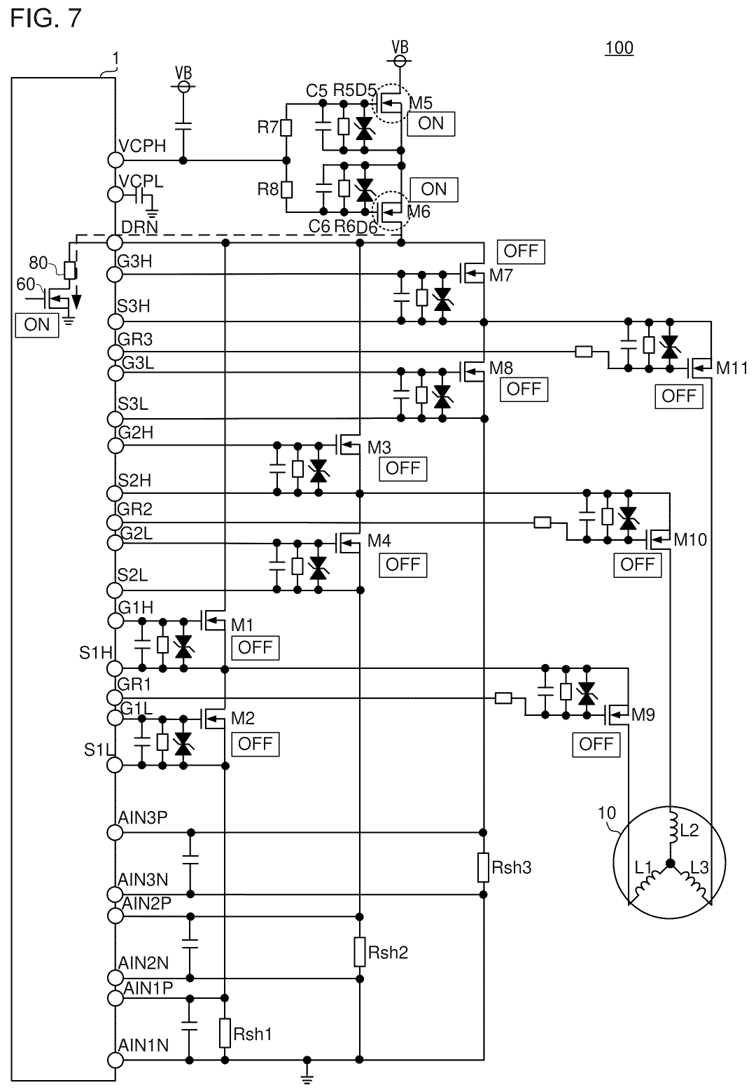

FIG. 7 is a diagram showing the operation state of the motor system 100 during open circuit checks of the power supply relays M5 and M6. In this case, in order to bring the charge pump 2 into an on state, the power supply relays M5 and M6 are in an on state, the transistors M1, M2, M3, M4, M7 and M8 are in an off state and the motor relays M9, M10 and M11 are in an off state. The pull-down switch 60 is brought into an on state to pull down the DRN terminal. After the check operations shown in FIG. 7, the charge pump 2 is kept in an on state.

When in the operation state shown in FIG. 7, both the power supply relays M5 and M6 are in an on state during normal conditions, the voltage at the DRN terminal is the battery voltage VB. On the other hand, when an open circuit occurs in at least the power supply relay M6 of the power supply relays M5 and M6, the voltage at the DRN terminal is the ground potential. Hence, it is possible to perform open circuit checks of the power supply relays M5 and M6 using the output of the comparator 90 (FIG. 2).

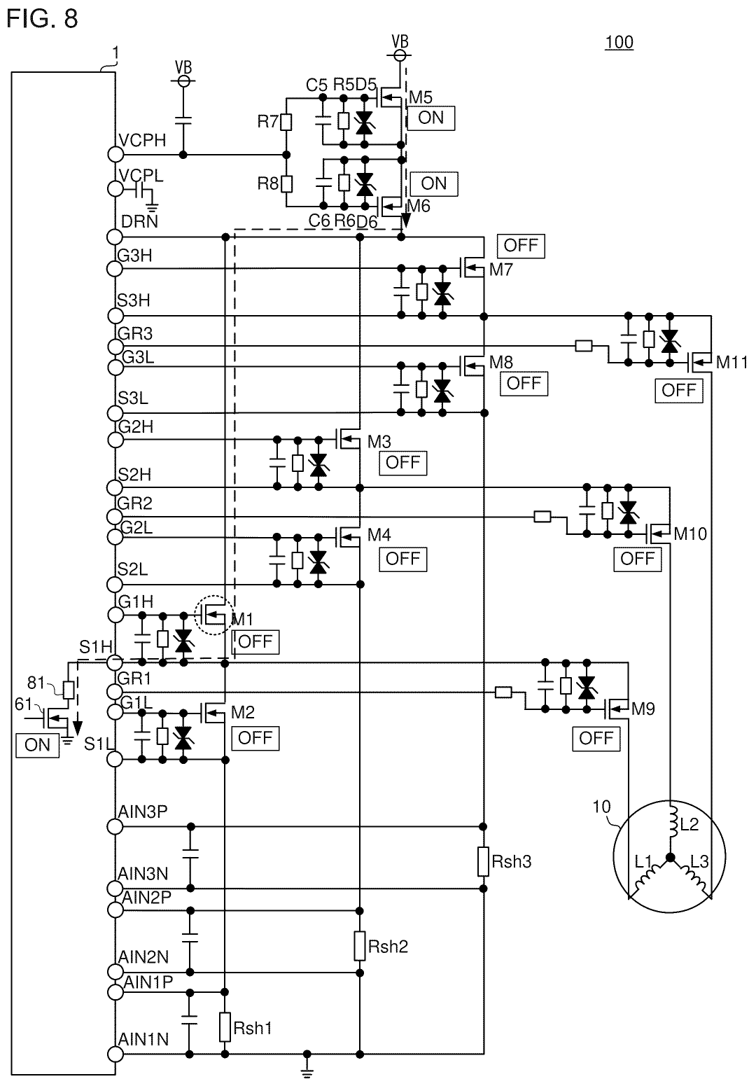

FIG. 8 is a diagram showing the operation state of the motor system 100 during a short circuit check of the first upper transistor M1. In this case, the power supply relays M5 and M6 are in an on state, the transistors M1, M2, M3, M4, M7 and M8 are in an off state and the motor relays M9, M10 and M11 are in an off state. The pull-down switch 61 is brought into an on state to pull down the S1H terminal.

When in the operation state shown in FIG. 8, the first upper transistor M1 is in an off state during normal conditions, the voltage at the S1H terminal is the ground potential. On the other hand, when a short circuit occurs in the first upper transistor M1, the voltage at the DRN terminal is the battery voltage VB. Hence, the reference voltage V91 for the comparator 91 (FIG. 2) is set between the ground potential and the battery voltage VB, and thus it is possible to perform a short circuit check of the first upper transistor M1 using the output of the comparator 91.

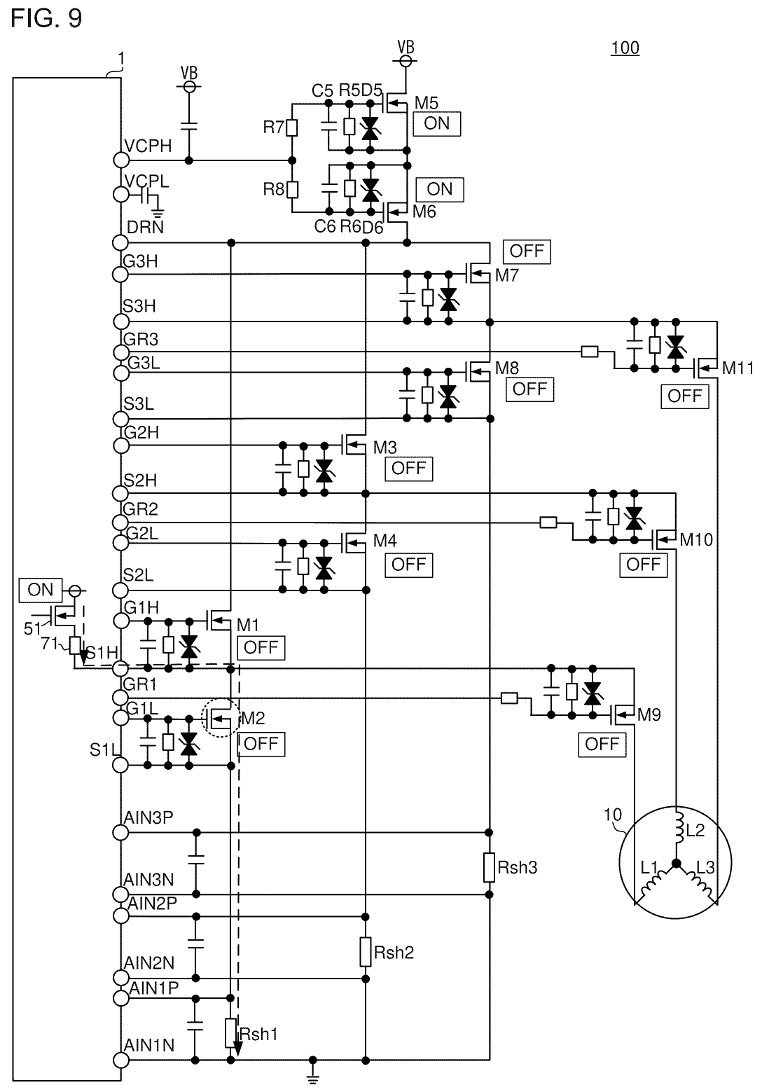

FIG. 9 is a diagram showing the operation state of the motor system 100 during a short circuit check of the first lower transistor M2. In this case, the power supply relays M5 and M6 are in an on state, the transistors M1, M2, M3, M4, M7 and M8 are in an off state and the motor relays M9, M10 and M11 are in an off state. The pull-up switch 51 is brought into an on state to pull up the S1H terminal.

When in the operation state shown in FIG. 9, the first lower transistor M2 is in an off state during normal conditions, the voltage at the S1H terminal is the battery voltage VB. On the other hand, when a short circuit occurs in the first lower transistor M2, the voltage at the S1H terminal is the ground potential. Hence, it is possible to perform a short circuit check of the first lower transistor M2 using the output of the comparator 91.

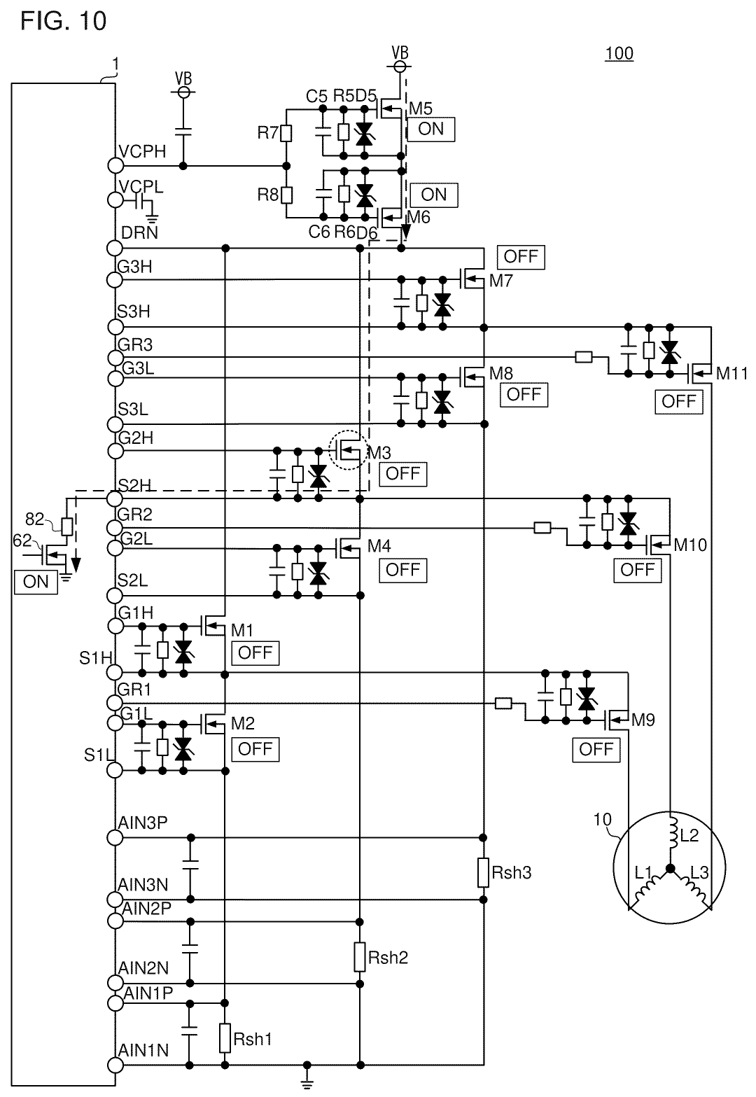

FIG. 10 is a diagram showing the operation state of the motor system 100 during a short circuit check of the second upper transistor M3. In this case, the power supply relays M5 and M6 are in an on state, the transistors M1, M2, M3, M4, M7 and M8 are in an off state and the motor relays M9, M10 and M11 are in an off state. The pull-down switch 62 is brought into an on state to pull down the S2H terminal.

When in the operation state shown in FIG. 10, the second upper transistor M3 is in an off state during normal conditions, the voltage at the S2H terminal is the ground potential. On the other hand, when a short circuit occurs in the second upper transistor M3, the voltage at the S2H terminal is the battery voltage VB. Hence, the reference voltage V92 for the comparator 92 (FIG. 2) is set between the ground potential and the battery voltage VB, and thus it is possible to perform a short circuit check of the second upper transistor M3 using the output of the comparator 92.

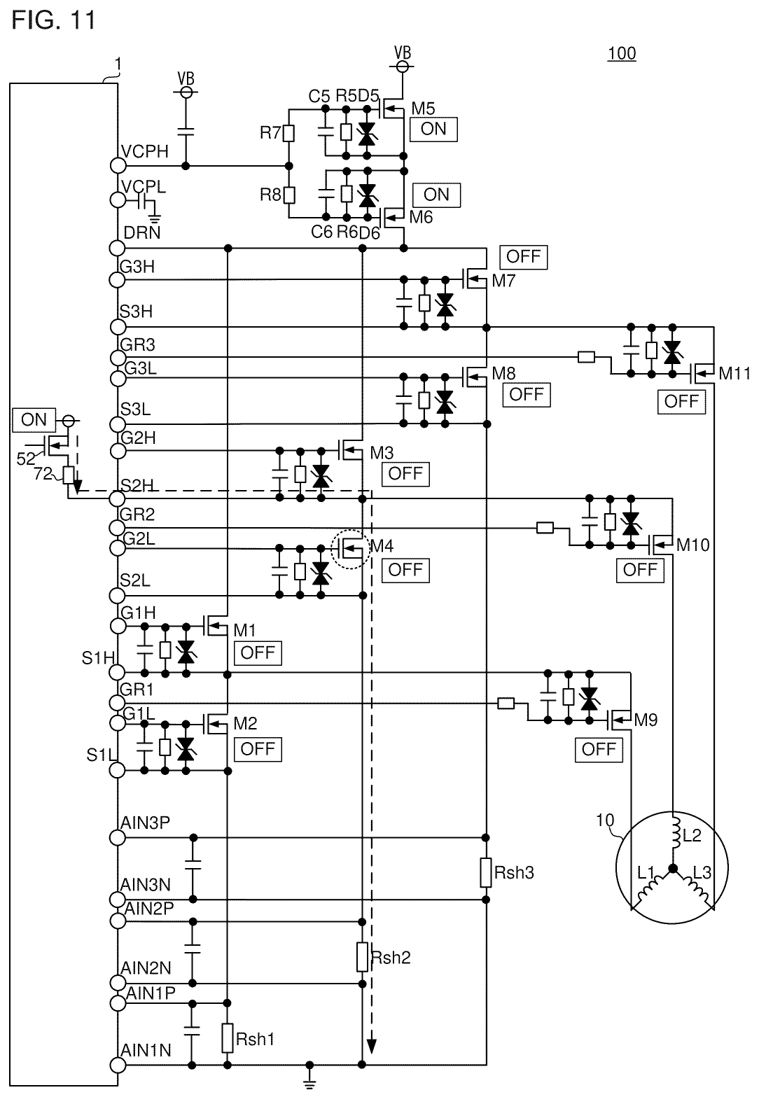

FIG. 11 is a diagram showing the operation state of the motor system 100 during a short circuit check of the second lower transistor M4. In this case, the power supply relays M5 and M6 are in an on state, the transistors M1, M2, M3, M4, M7 and M8 are in an off state and the motor relays M9, M10 and M11 are in an off state. The pull-up switch 52 is brought into an on state to pull up the S2H terminal.

When in the operation state shown in FIG. 11, the second lower transistor M4 is in an off state during normal conditions, the voltage at the S2H terminal is the battery voltage VB. On the other hand, when a short circuit occurs in the second lower transistor M4, the voltage at the S2H terminal is the ground potential. Hence, it is possible to perform a short circuit check of the second lower transistor M4 using the output of the comparator 92.

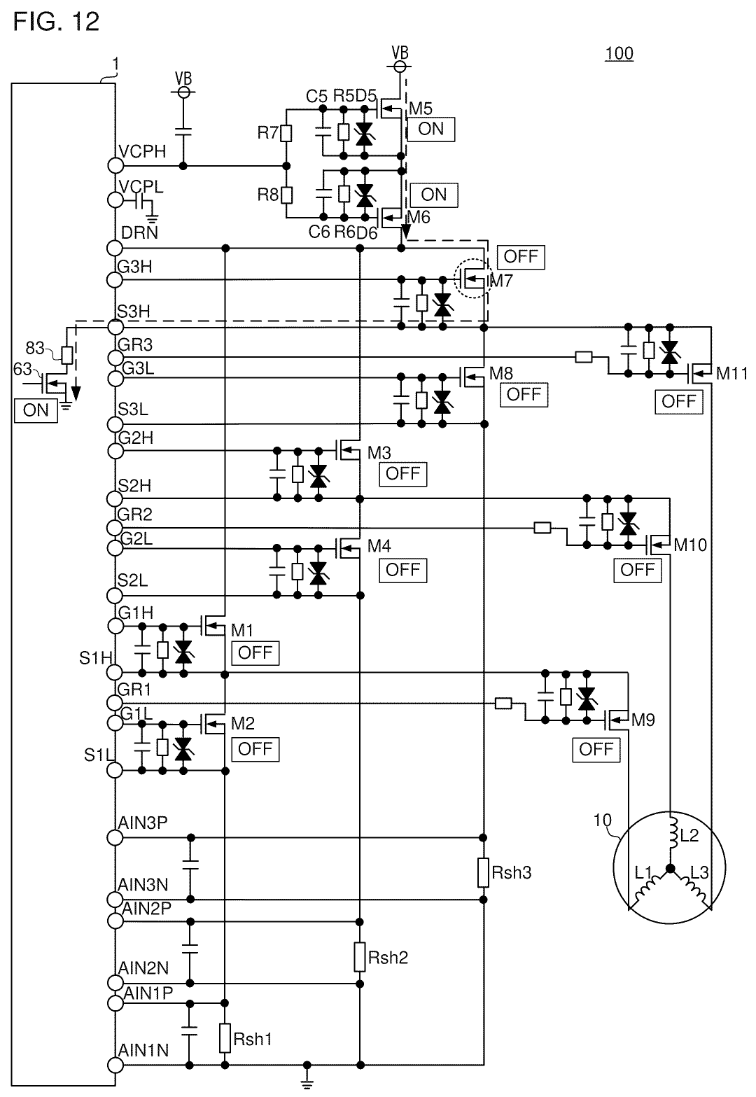

FIG. 12 is a diagram showing the operation state of the motor system 100 during a short circuit check of the third upper transistor M7. In this case, the power supply relays M5 and M6 are in an on state, the transistors M1, M2, M3, M4, M7 and M8 are in an off state and the motor relays M9, M10 and M11 are in an off state. The pull-down switch 63 is brought into an on state to pull down the S3H terminal.

When in the operation state shown in FIG. 12, the third upper transistor M7 is in an off state during normal conditions, the voltage at the S3H terminal is the ground potential. On the other hand, when a short circuit occurs in the third upper transistor M7, the voltage at the S3H terminal is the battery voltage VB. Hence, the reference voltage V93 for the comparator 93 (FIG. 2) is set between the ground potential and the battery voltage VB, and thus it is possible to perform a short circuit check of the third upper transistor M7 using the output of the comparator 93.

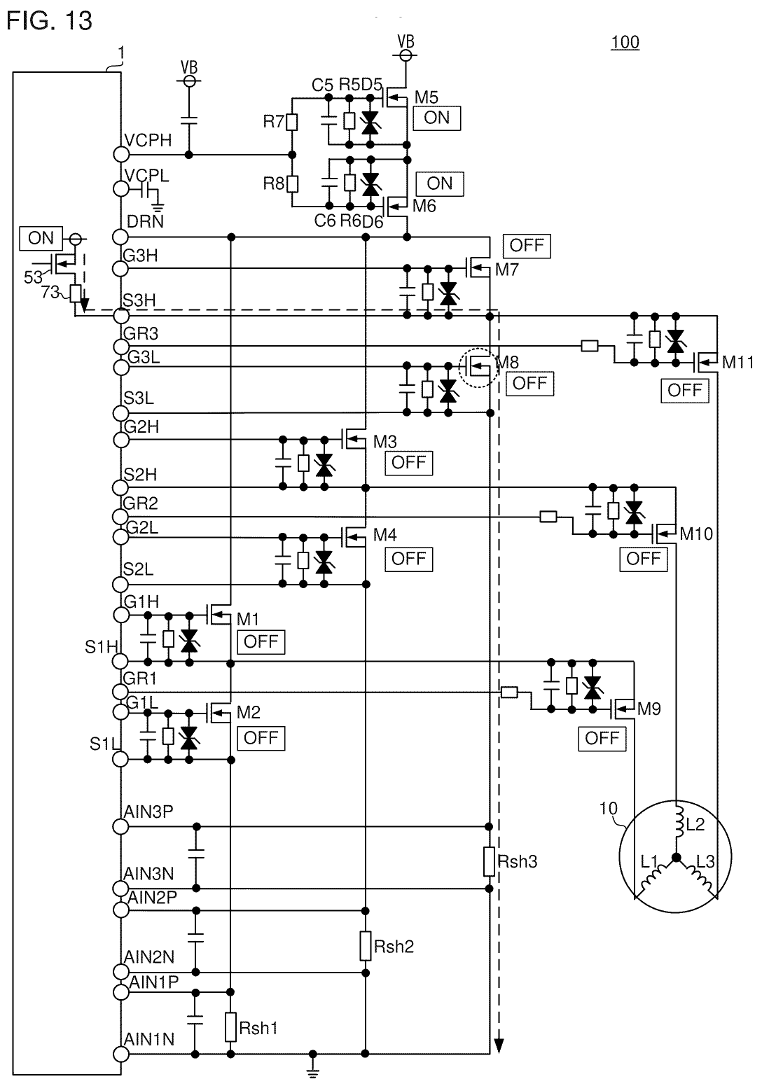

FIG. 13 is a diagram showing the operation state of the motor system 100 during a short circuit check of the third lower transistor M8. In this case, the power supply relays M5 and M6 are in an on state, the transistors M1, M2, M3, M4, M7 and M8 are in an off state and the motor relays M9, M10 and M11 are in an off state. The pull-up switch 53 is brought into an on state to pull up the S3H terminal.

When in the operation state shown in FIG. 13, the third lower transistor M8 is in an off state during normal conditions, the voltage at the S3H terminal is the battery voltage VB. On the other hand, when a short circuit occurs in the third lower transistor M8, the voltage at the S3H terminal is the ground potential. Hence, it is possible to perform a short circuit check of the third lower transistor M8 using the output of the comparator 93.

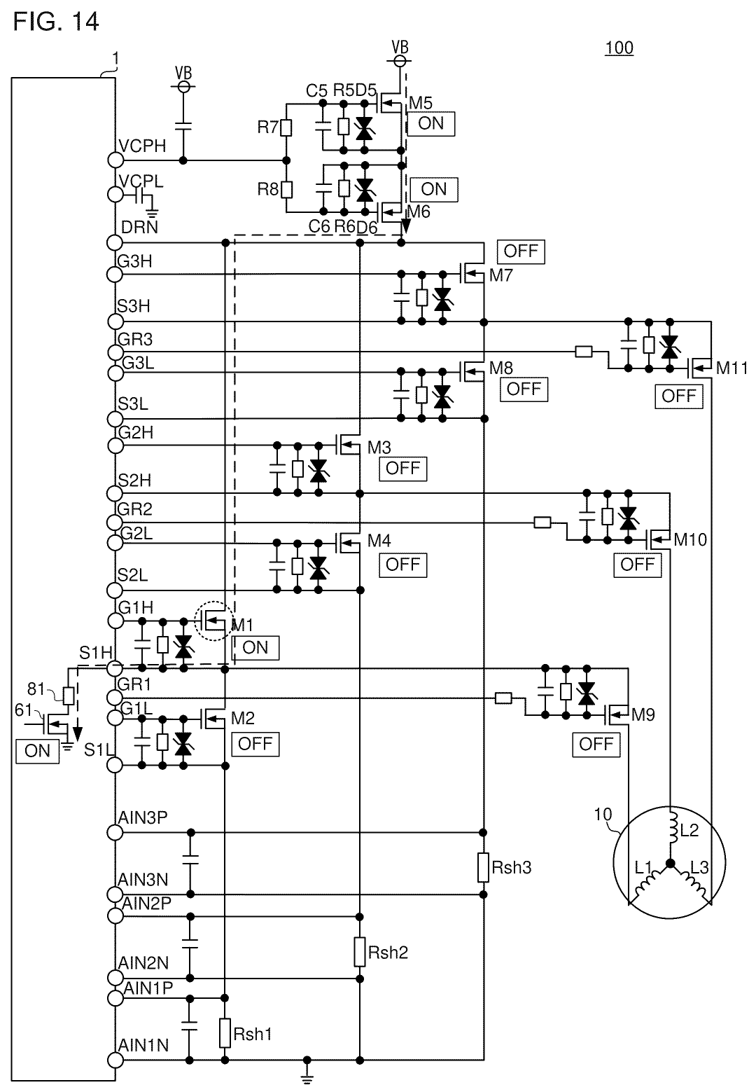

FIG. 14 is a diagram showing the operation state of the motor system 100 during an open circuit check of the first upper transistor M1. In this case, the power supply relays M5 and M6 are in an on state, the transistor M1 is in an on state, the transistors M2, M3, M4, M7 and M8 are in an off state and the motor relays M9, M10 and M11 are in an off state. The pull-down switch 61 is brought into an on state to pull down the S1H terminal.

When in the operation state shown in FIG. 14, the first upper transistor M1 is in an on state during normal conditions, the voltage at the S1H terminal is the battery voltage VB. On the other hand, when an open circuit occurs in the first upper transistor M1, the voltage at the S1H terminal is the ground potential. Hence, it is possible to perform an open circuit check of the first upper transistor M1 using the output of the comparator 91.

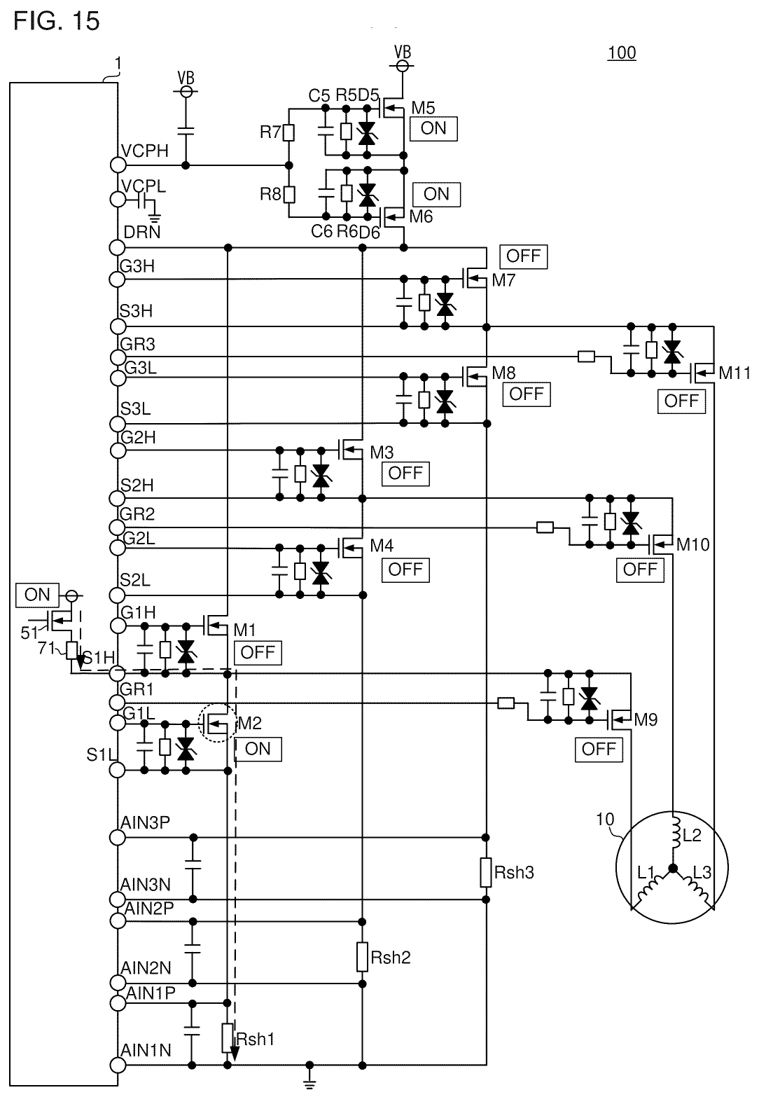

FIG. 15 is a diagram showing the operation state of the motor system 100 during an open circuit check of the first lower transistor M2. In this case, the power supply relays M5 and M6 are in an on state, the transistor M2 is in an on state, the transistors M1, M3, M4, M7 and M8 are in an off state and the motor relays M9, M10 and M11 are in an off state. The pull-up switch 51 is brought into an on state to pull up the S1H terminal.

When in the operation state shown in FIG. 15, the first lower transistor M2 is in an on state during normal conditions, the voltage at the S1H terminal is the ground potential. On the other hand, when an open circuit occurs in the first lower transistor M2, the voltage at the S1H terminal is the battery voltage VB. Hence, it is possible to perform an open circuit check of the first lower transistor M2 using the output of the comparator 91.

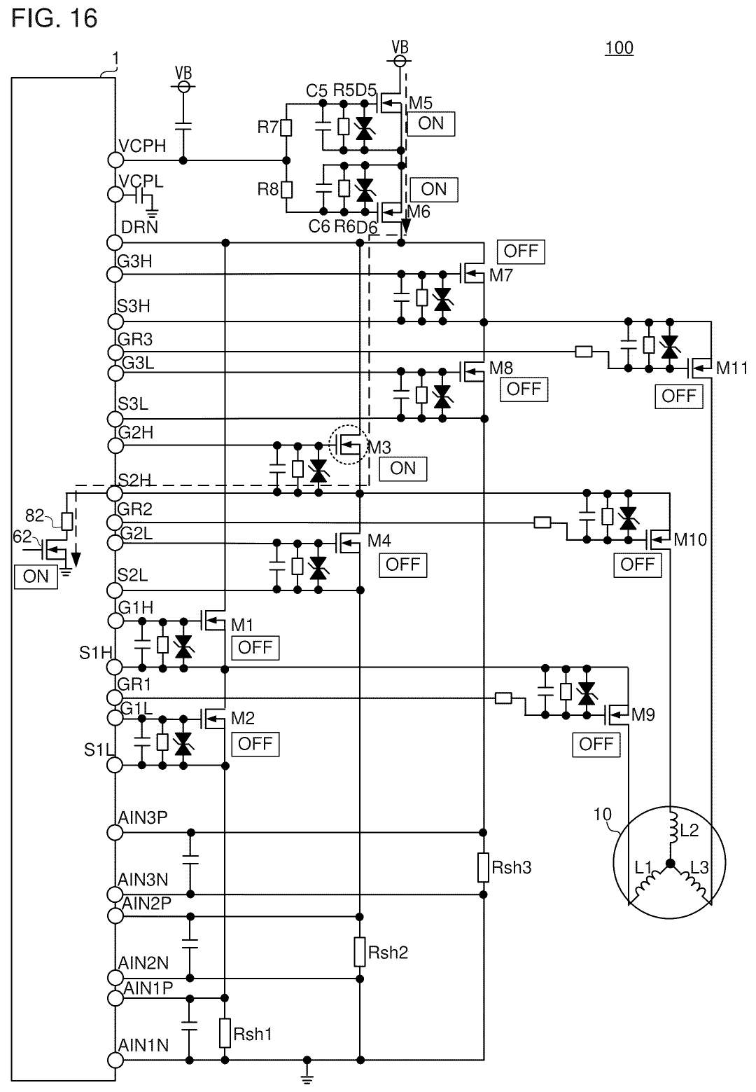

FIG. 16 is a diagram showing the operation state of the motor system 100 during an open circuit check of the second upper transistor M3. In this case, the power supply relays M5 and M6 are in an on state, the transistor M3 is in an on state, the transistors M1, M2, M4, M7 and M8 are in an off state and the motor relays M9, M10 and M11 are in an off state. The pull-down switch 62 is brought into an on state to pull down the S2H terminal.

When in the operation state shown in FIG. 16, the second upper transistor M3 is in an on state during normal conditions, the voltage at the S2H terminal is the battery voltage VB. On the other hand, when an open circuit occurs in the second upper transistor M3, the voltage at the S2H terminal is the ground potential. Hence, it is possible to perform an open circuit check of the second upper transistor M3 using the output of the comparator 92.

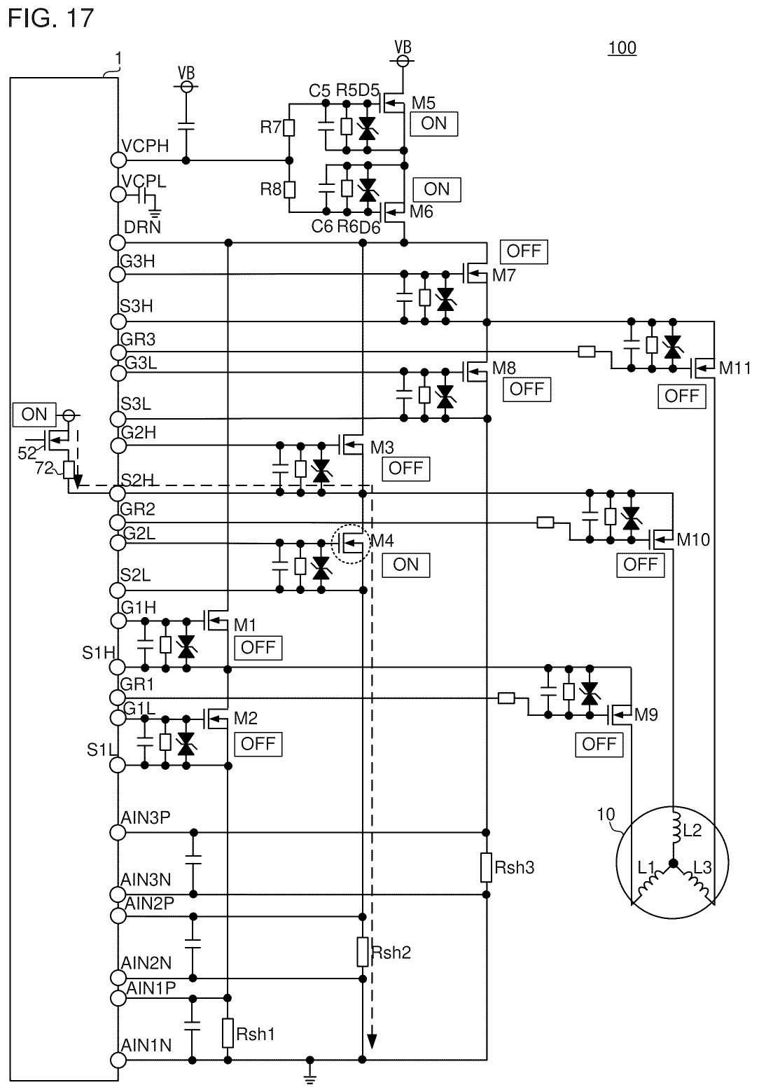

FIG. 17 is a diagram showing the operation state of the motor system 100 during an open circuit check of the second lower transistor M4. In this case, the power supply relays M5 and M6 are in an on state, the transistor M4 is in an on state, the transistors M1, M2, M3, M7 and M8 are in an off state and the motor relays M9, M10 and M11 are in an off state. The pull-up switch 52 is brought into an on state to pull up the S2H terminal.

When in the operation state shown in FIG. 17, the second lower transistor M4 is in an on state during normal conditions, the voltage at the S2H terminal is the ground potential. On the other hand, when an open circuit occurs in the second lower transistor M4, the voltage at the S2H terminal is the battery voltage VB. Hence, it is possible to perform an open circuit check of the second lower transistor M4 using the output of the comparator 92.

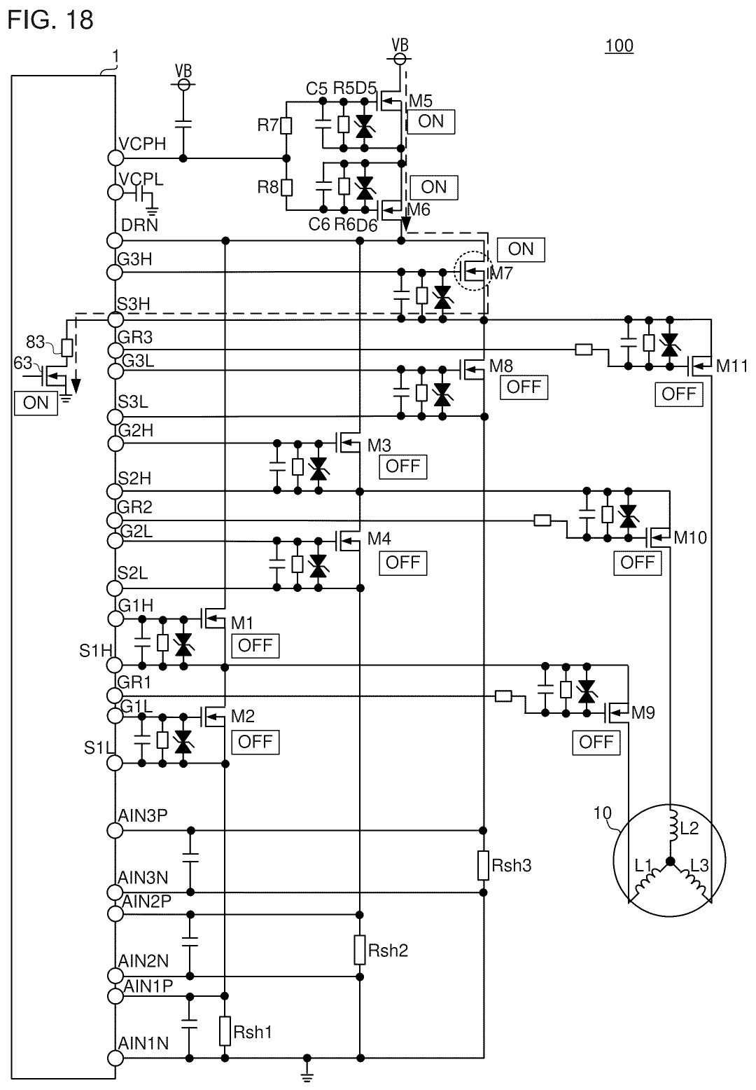

FIG. 18 is a diagram showing the operation state of the motor system 100 during an open circuit check of the third upper transistor M7. In this case, the power supply relays M5 and M6 are in an on state, the transistor M7 is in an on state, the transistors M1, M2, M3, M4 and M8 are in an off state and the motor relays M9, M10 and M11 are in an off state. The pull-down switch 63 is brought into an on state to pull down the S3H terminal.

When in the operation state shown in FIG. 18, the third upper transistor M7 is in an on state during normal conditions, the voltage at the S3H terminal is the battery voltage VB. On the other hand, when an open circuit occurs in the third upper transistor M7, the voltage at the S3H terminal is the ground potential. Hence, it is possible to perform an open circuit check of the third upper transistor M7 using the output of the comparator 93.

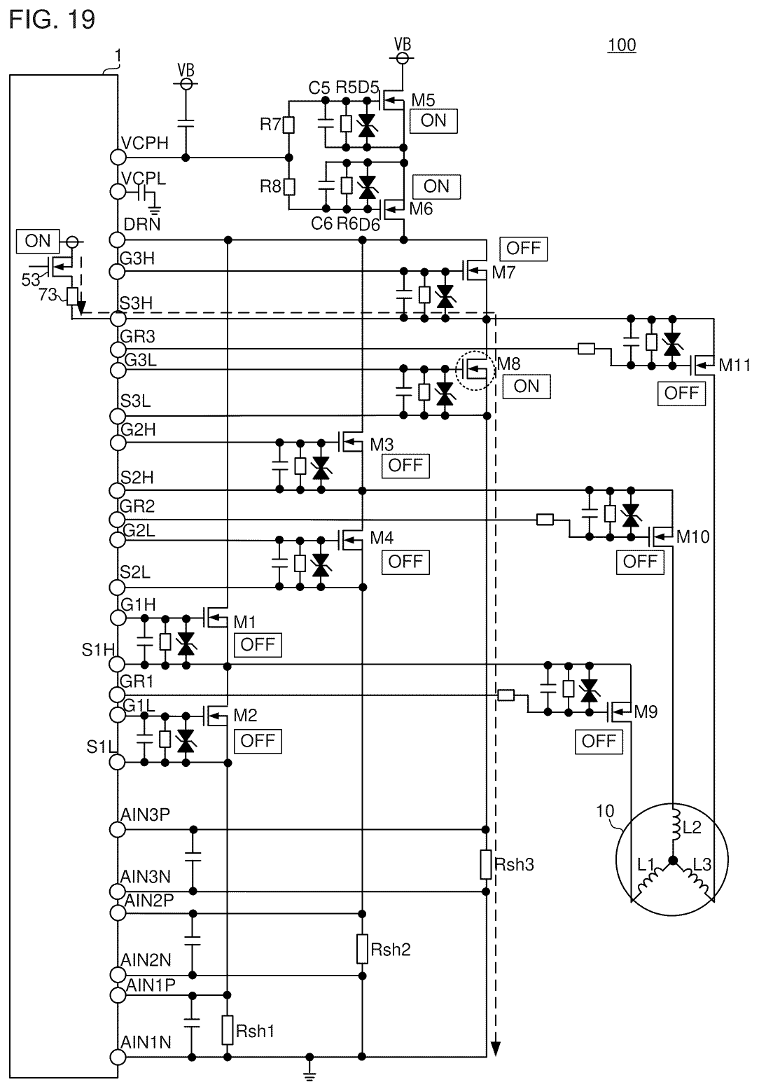

FIG. 19 is a diagram showing the operation state of the motor system 100 during an open circuit check of the third lower transistor M8. In this case, the power supply relays M5 and M6 are in an on state, the transistor M8 is in an on state, the transistors M1, M2, M3, M4 and M7 are in an off state and the motor relays M9, M10 and M11 are in an off state. The pull-up switch 53 is brought into an on state to pull up the S3H terminal.

When in the operation state shown in FIG. 19, the third lower transistor M8 is in an on state during normal conditions, the voltage at the S3H terminal is the ground potential. On the other hand, when an open circuit occurs in the third lower transistor M8, the voltage at the S3H terminal is the battery voltage VB. Hence, it is possible to perform an open circuit check of the third lower transistor M8 using the output of the comparator 93.

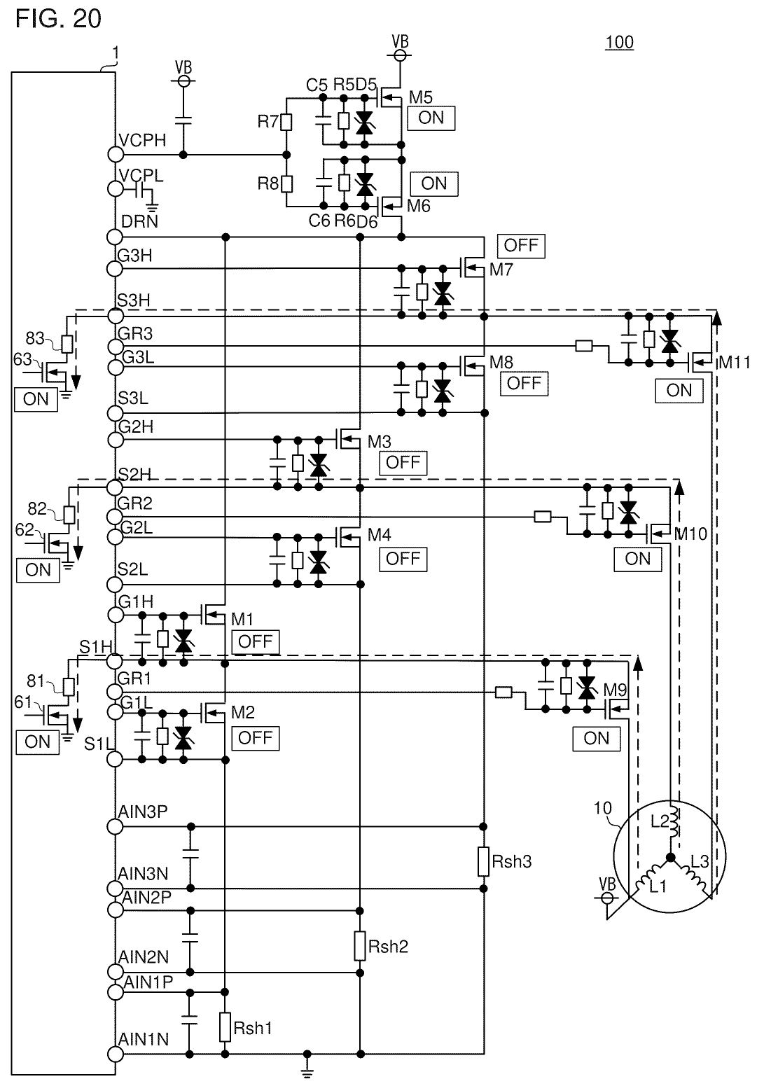

FIG. 20 is a diagram showing the operation state of the motor system 100 during a short-to-power check of the motor 10. In this case, the power supply relays M5 and M6 are in an on state, the transistors M1, M2, M3, M4, M7 and M8 are in an off state and the motor relays M9, M10 and M11 are in an on state. The pull-down switches 61, 62 and 63 are brought into an on state to pull down the S1H, S2H and S3H terminals.

When in the operation state shown in FIG. 20, a short-to-power does not occur in the motor 10, all the voltages at the S1H, S2H and S3H terminals are the ground potential. On the other hand, when a short-to-power occurs in the motor 10, at least one of the voltages at the S1H, S2H and S3H terminals are the battery voltage VB. Hence, it is possible to perform a short-to-power check of the motor 10 using the outputs of the comparators 91, 92 and 93. FIG. 20 shows a case where a short-to-power occurs at the U-phase terminal of the motor 10. In particular, since all the motor relays M9, M10 and M11 are brought into an on state, even if an open circuit occurs in one of the motor relays M9, M10 and M11, at least one of the voltages at the S1H, S2H and S3H terminals are the battery voltage VB when a short-to-power occurs in the motor 10.

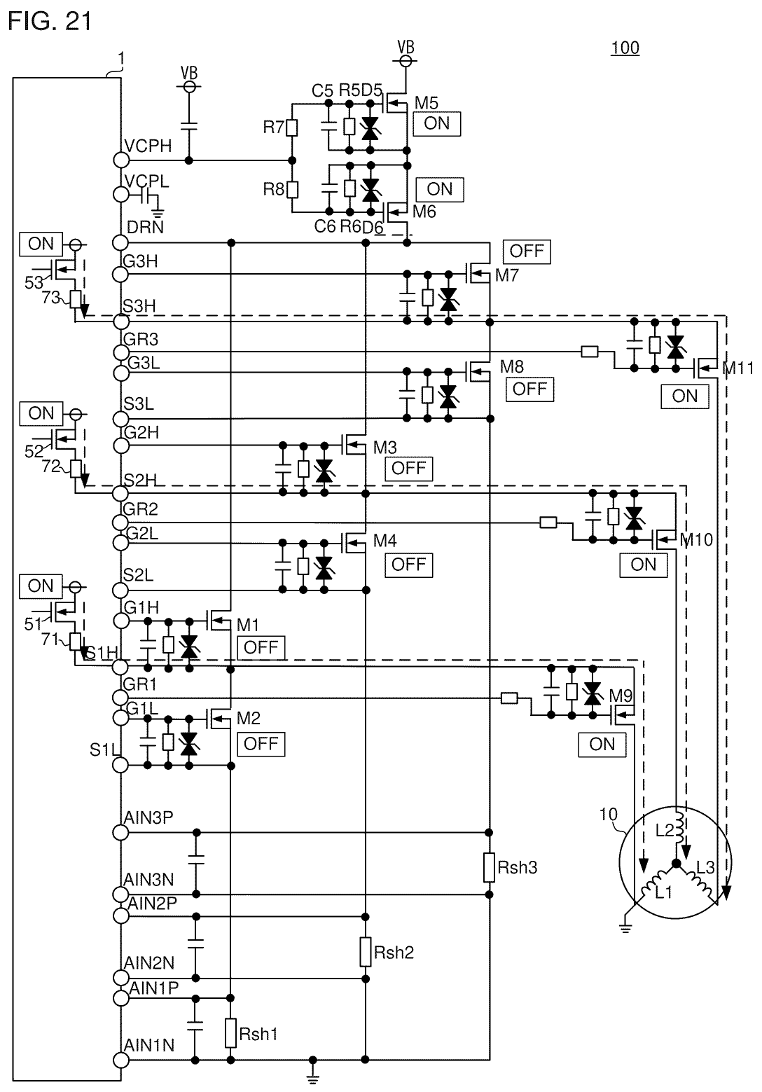

FIG. 21 is a diagram showing the operation state of the motor system 100 during a ground fault check of the motor 10. In this case, the power supply relays M5 and M6 are in an on state, the transistors M1, M2, M3, M4, M7 and M8 are in an off state and the motor relays M9, M10 and M11 are in an on state. The pull-up switches 51, 52 and 53 are brought into an on state to pull up the S1H, S2H and S3H terminals.

When in the operation state shown in FIG. 21, a ground fault does not occur in the motor 10, all the voltages at the S1H, S2H and S3H terminals are the battery voltage VB. On the other hand, when a ground fault occurs in the motor 10, at least one of the voltages at the S1H, S2H and S3H terminals are the ground potential. Hence, it is possible to perform a ground fault check of the motor 10 using the outputs of the comparators 91, 92 and 93. FIG. 21 shows a case where a ground fault occurs at the U-phase terminal of the motor 10. In particular, since all the motor relays M9, M10 and M11 are brought into an on state, even if an open circuit occurs in one of the motor relays M9, M10 and M11, at least one of the voltages at the S1H, S2H and S3H terminals are the ground potential when a ground fault occurs in the motor 10.

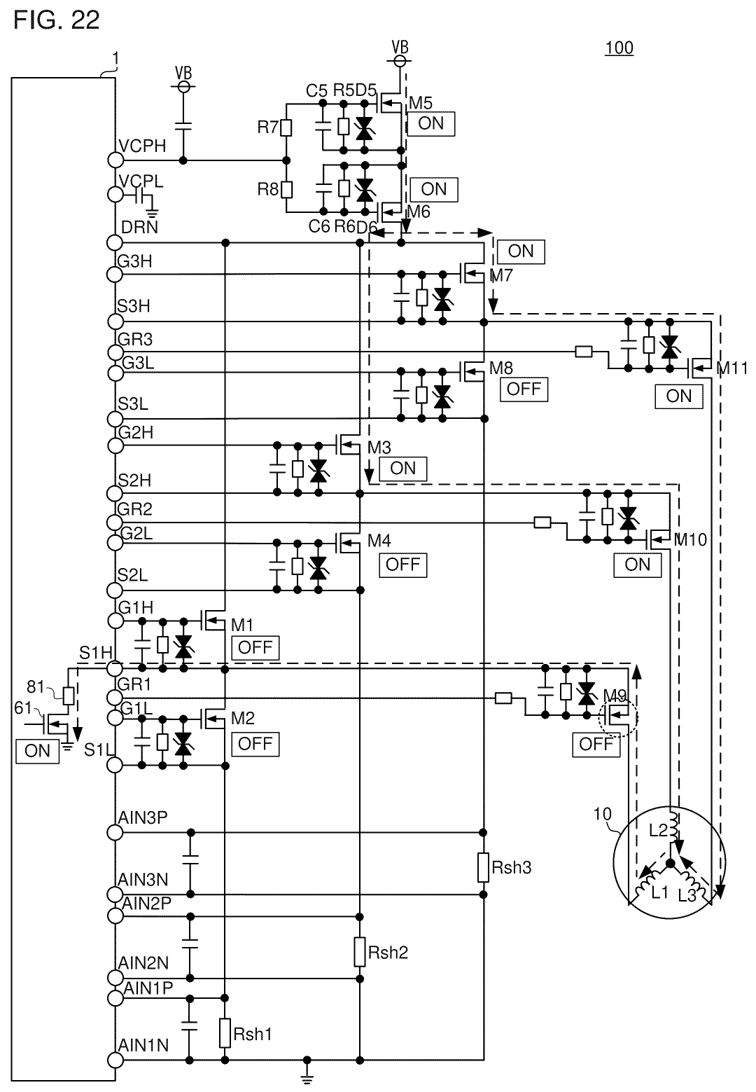

FIG. 22 is a diagram showing the operation state of the motor system 100 during a short circuit check of the first motor relay M9. In this case, the power supply relays M5 and M6 are in an on state, the transistors M1, M2, M4 and M8 are in an off state, the transistors M3 and M7 are in an on state, the motor relay M9 is in an off state and the motor relays M10 and M11 are in an on state. The pull-down switch 61 is brought into an on state to pull down the SH terminal.

When in the operation state shown in FIG. 22, the first motor relay M9 is in an off state during normal conditions, the voltage at the S1H terminal is the ground potential. On the other hand, when a short circuit occurs in the first motor relay M9, the voltage at the S1H terminal is the battery voltage VB. Hence, it is possible to perform a short circuit check of the first motor relay M9 using the output of the comparator 91. In particular, even if an open circuit occurs in one of the motor relays M10 and M11, the voltage at the S1H terminal is the battery voltage VB when a short circuit occurs in the first motor relay M9.

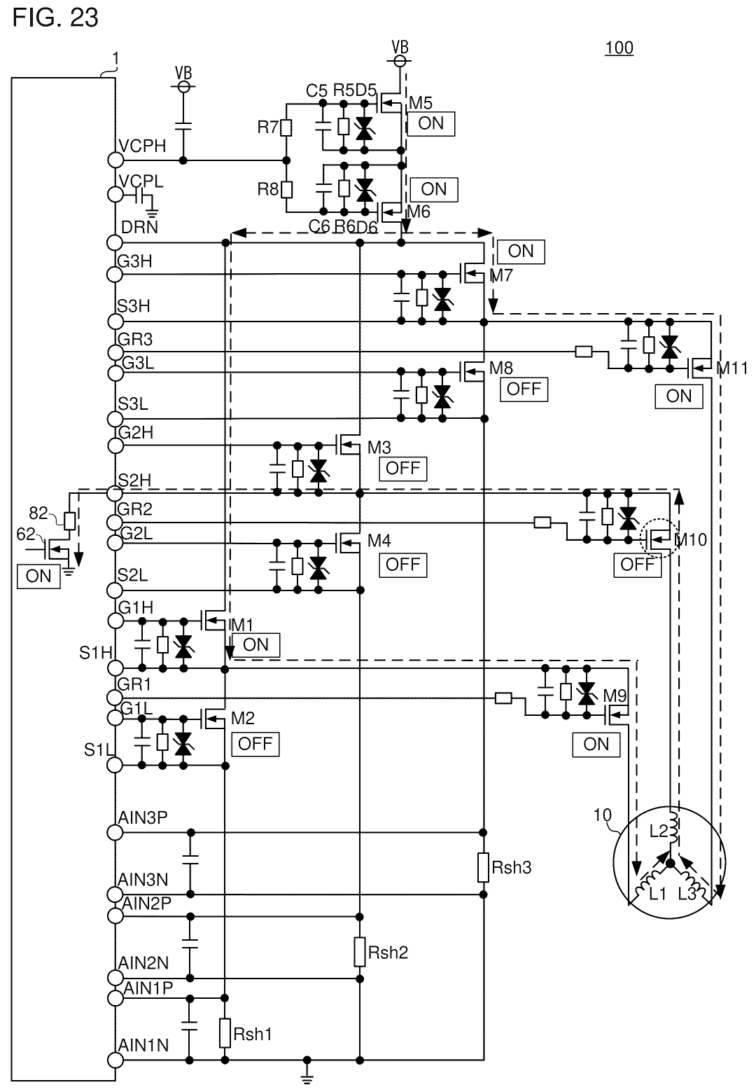

FIG. 23 is a diagram showing the operation state of the motor system 100 during a short circuit check of the second motor relay M10. In this case, the power supply relays M5 and M6 are in an on state, the transistors M2, M3, M4 and M8 are in an off state, the transistors M1 and M7 are in an on state, the motor relay M10 is in an off state and the motor relays M9 and M11 are in an on state. The pull-down switch 62 is brought into an on state to pull down the S2H terminal.

When in the operation state shown in FIG. 23, the second motor relay M10 is in an off state during normal conditions, the voltage at the S2H terminal is the ground potential. On the other hand, when a short circuit occurs in the second motor relay M10, the voltage at the S2H terminal is the battery voltage VB. Hence, it is possible to perform a short circuit check of the second motor relay M10 using the output of the comparator 92. In particular, even if an open circuit occurs in one of the motor relays M9 and M11, the voltage at the S2H terminal is the battery voltage VB when a short circuit occurs in the second motor relay M10.

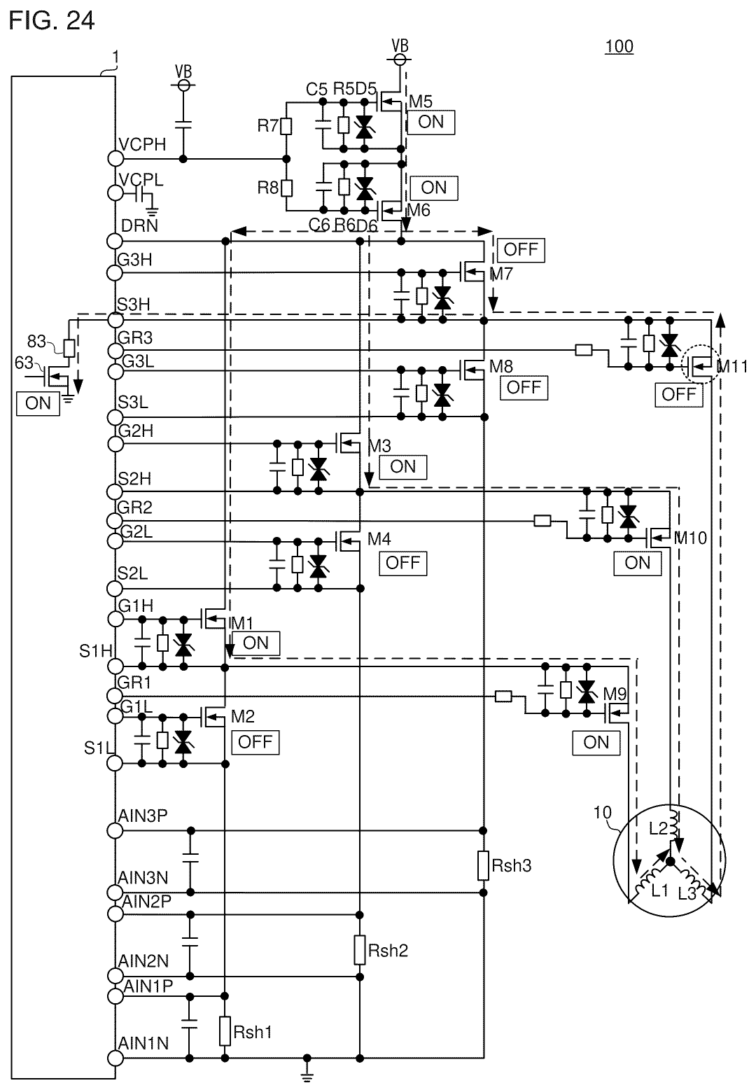

FIG. 24 is a diagram showing the operation state of the motor system 100 during a short circuit check of the third motor relay M11. In this case, the power supply relays M5 and M6 are in an on state, the transistors M2, M4, M7 and M8 are in an off state, the transistors M1 and M3 are in an on state, the motor relay M11 is in an off state and the motor relays M9 and M10 are in an on state. The pull-down switch 63 is brought into an on state to pull down the S3H terminal.

When in the operation state shown in FIG. 24, the third motor relay M11 is in an off state during normal conditions, the voltage at the S3H terminal is the ground potential. On the other hand, when a short circuit occurs in the third motor relay M11, the voltage at the S3H terminal is the battery voltage VB. Hence, it is possible to perform a short circuit check of the third motor relay M11 using the output of the comparator 93. In particular, even if an open circuit occurs in one of the motor relays M9 and M10, the voltage at the S3H terminal is the battery voltage VB when a short circuit occurs in the third motor relay M11.

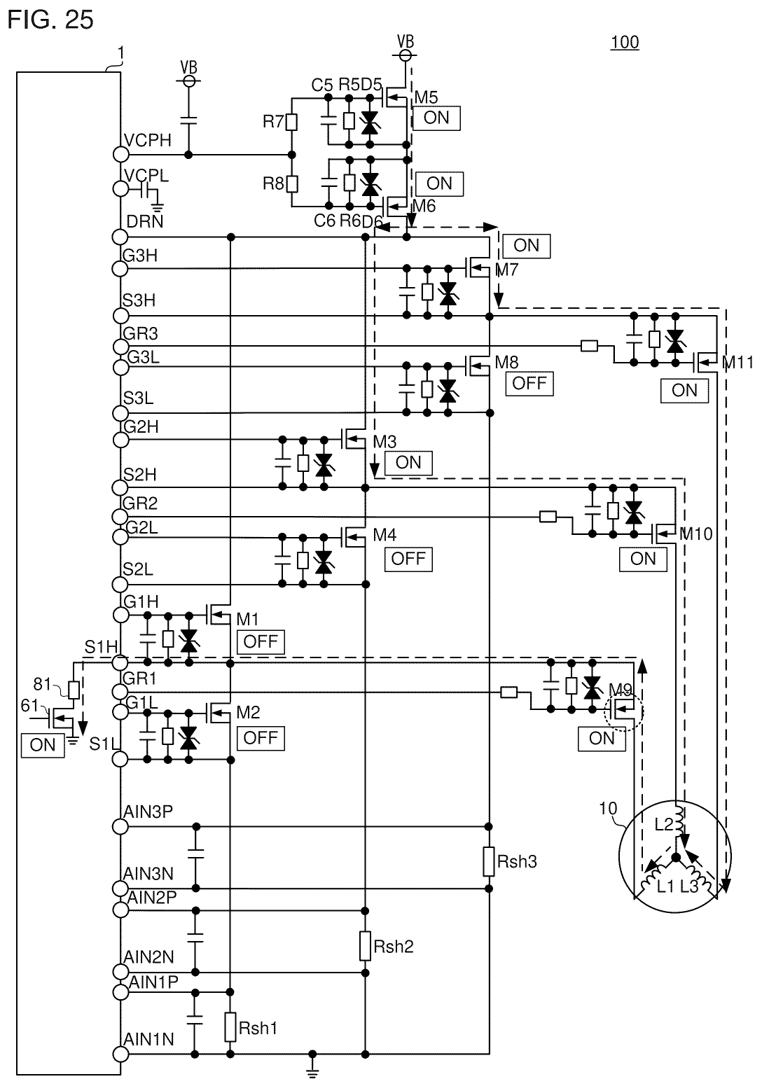

FIG. 25 is a diagram showing the operation state of the motor system 100 during an open circuit check of the first motor relay M9. In this case, the power supply relays M5 and M6 are in an on state, the transistors M1, M2, M4 and M8 are in an off state, the transistors M3 and M7 are in an on state and the motor relays M9, M10 and M11 are in an on state. The pull-down switch 61 is brought into an on state to pull down the S1H terminal.

When in the operation state shown in FIG. 25, the first motor relay M9 is in an on state during normal conditions, the voltage at the S1H terminal is the battery voltage VB. On the other hand, when an open circuit occurs in the first motor relay M9, the voltage at the S1H terminal is the ground potential. Hence, it is possible to perform an open circuit check of the first motor relay M9 using the output of the comparator 91. In particular, even if an open circuit occurs in one of the motor relays M10 and M11, the voltage at the S1H terminal is the battery voltage VB when the first motor relay M9 is normal.

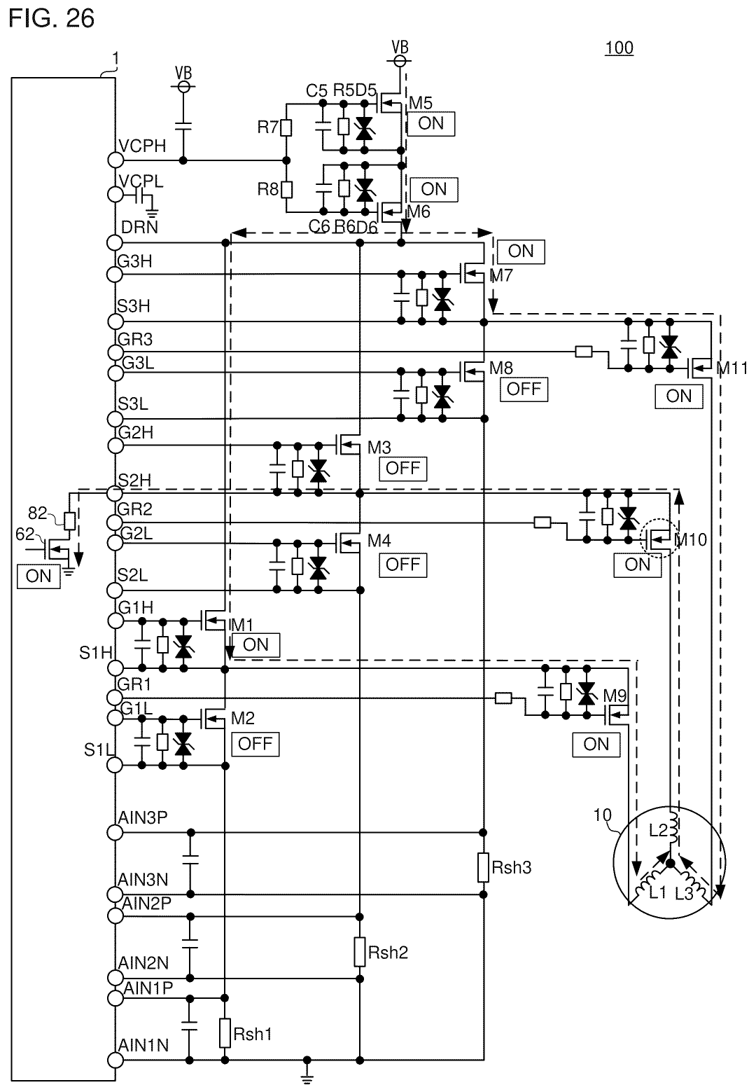

FIG. 26 is a diagram showing the operation state of the motor system 100 during an open circuit check of the second motor relay M10. In this case, the power supply relays M5 and M6 are in an on state, the transistors M2, M3, M4 and M8 are in an off state, the transistors M1 and M7 are in an on state and the motor relays M9, M10 and M11 are in an on state. The pull-down switch 62 is brought into an on state to pull down the S2H terminal.

When in the operation state shown in FIG. 26, the second motor relay M10 is in an on state during normal conditions, the voltage at the S2H terminal is the battery voltage VB. On the other hand, when an open circuit occurs in the second motor relay M10, the voltage at the S2H terminal is the ground potential. Hence, it is possible to perform an open circuit check of the second motor relay M10 using the output of the comparator 92. In particular, even if an open circuit occurs in one of the motor relays M9 and M11, the voltage at the S2H terminal is the battery voltage VB when the second motor relay M10 is normal.

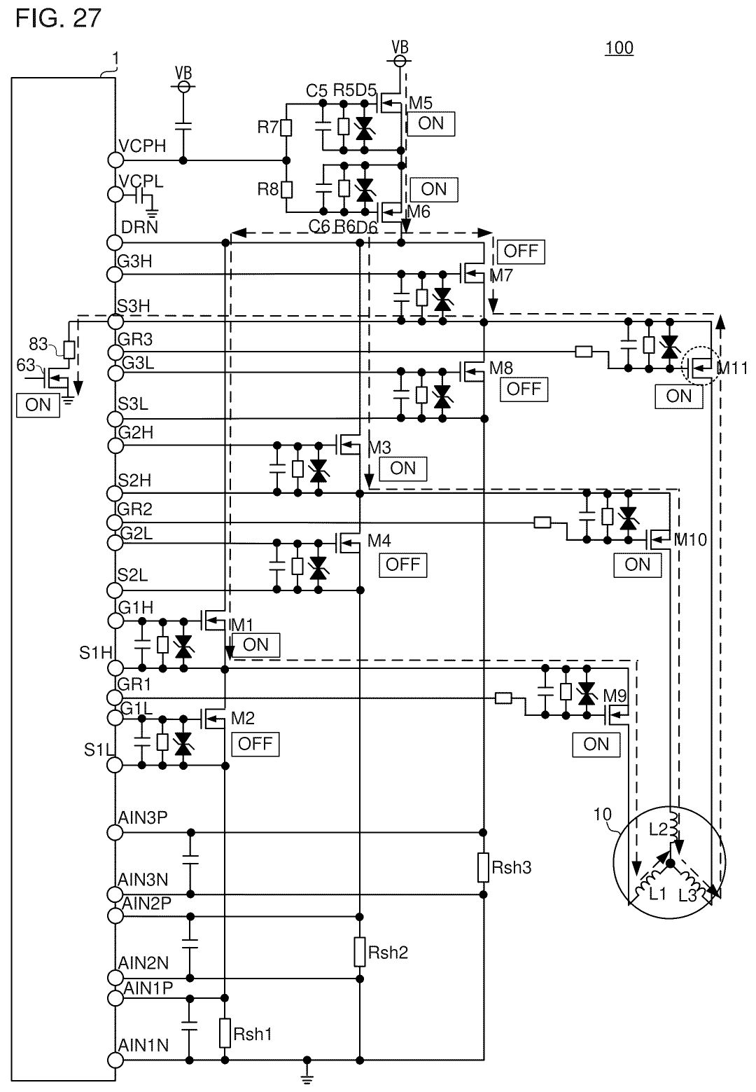

FIG. 27 is a diagram showing the operation state of the motor system 100 during an open circuit check of the third motor relay M11. In this case, the power supply relays M5 and M6 are in an on state, the transistors M2, M4, M7 and M8 are in an off state, the transistors M1 and M3 are in an on state and the motor relays M9, M10 and M11 are in an on state. The pull-down switch 63 is brought into an on state to pull down the S3H terminal.

When in the operation state shown in FIG. 27, the third motor relay M11 is in an on state during normal conditions, the voltage at the S3H terminal is the battery voltage VB. On the other hand, when an open circuit occurs in the third motor relay M11, the voltage at the S3H terminal is the ground potential. Hence, it is possible to perform an open circuit check of the third motor relay M11 using the output of the comparator 93. In particular, even if an open circuit occurs in one of the motor relays M9 and M10, the voltage at the S3H terminal is the battery voltage VB when the third motor relay M11 is normal.

In the present embodiment as described above, at startup, short circuit/open circuit checks of the power supply relays M5 and M6, short circuit/open circuit checks of the transistors M1, M2, M3, M4, M7 and M8, a short-to-power/ground fault check of the motor 10 and short circuit/open circuit checks of the motor relays M9, M10 and M11 can be performed.

In particular, in the present embodiment, each of the on-resistance values of the pull-down switches 60 to 63 and the pull-up switches 51 to 53 used for the check operations is set higher than each of the on-resistance values of the transistors M1, M2, M3, M4, M7 and M8. If the transistors M1, M2, M3, M4, M7 and M8 are used to perform the pulling down or the pulling up, a through current may flow through the half-bridges 1HB, 2HB and 3HB to affect the transistors of the half-bridges or to cause the motor 10 to operate. Hence, in the present embodiment, the on-resistance values of the pull-down switches 60 to 63 and the pull-up switches 51 to 53 are set high, and thus the current which flows during the check operations is restricted.

In the present embodiment, the pull-down resistors 80 to 83 and the pull-up resistors 71 to 73 are further provided, and thus the current which flows during the check operations is further restricted. The pull-down resistor and the pull-up resistor may include a plurality of resistor elements connected in series to increase the resistance. When the on-resistance values of the pull-down switches 60 to 63 and the pull-up switches 51 to 53 are sufficiently high, the pull-down resistor and the pull-up resistor may be omitted.

### <4. Application to Vehicle>

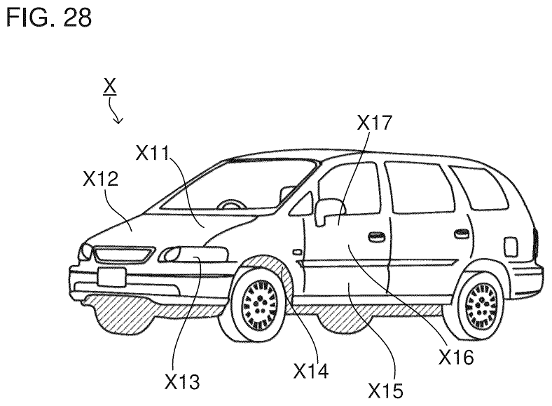

FIG. 28 is an external view showing an example of the configuration of a vehicle which incorporates the motor system 100 described above. In FIG. 28, as an example of the application of the motor 10, various types of motors X11 to X17 incorporated in the vehicle X are shown.

The motor X11 is an electric power steering motor. The motor X12 is an electric oil pump motor. The motor X13 is a headlight drive motor. The motor X14 is an electric parking brake motor. The motor X15 is a seat cooling fan motor. The motor X16 is a door opening/closing motor. The motor X17 is a door lock motor.

### <5. Others>

In addition to the embodiment described above, various changes can be made in various technical features disclosed in the present specification without departing from the spirit of the technical creation thereof. In other words, it should be considered that the embodiment is illustrative in all respects, and not restrictive, and it should be understood that the technical scope of the present invention is not limited to the embodiment and includes all changes in meanings and a scope equivalent to the scope of claims.

### <6. Additional Notes>

As described above, for example, a motor drive device (1) according to an aspect of the present disclosure is configured to drive a motor using at least one half-bridge (1HB, 2HB and 3HB) which includes an upper transistor (M1, M3 and M7) and a lower transistor (M2, M4 and M8) and in which the motor (10) is connectable to a node (N1, N2 and N3) where the upper transistor and the lower transistor are connected, the motor drive device includes:

at least one of a second main electrode pull-down switch (61, 62 and 63) configured to be able to pull down a second main electrode corresponding to the node in the upper transistor including a first main electrode configured to be able to apply a power supply voltage (VB) and a second main electrode pull-up switch (51, 52 and 53) configured to be able to pull up the second main electrode; a check performance unit (3) configured to perform an abnormality check operation for at least one of the upper transistor, the lower transistor and the motor in a state where the second main electrode is pulled up or pulled down by bringing one of the second main electrode pull-down switch and the second main electrode pull-up switch into an on state; and a control circuit (3) configured to control a combination of on/off states of the upper transistor, the lower transistor and a motor relay (M9, M10 and M11) connected to the motor and the check performance unit is configured to check, at startup, for at least one of a short circuit and an open circuit of the upper transistor, a short circuit and an open circuit of the lower transistor, a short-to-power and a ground fault of the motor and a short circuit and an open circuit of the motor relay (first configuration).

Preferably, in the first configuration described above, the check performance unit is configured to identify an abnormality by performing, in the following order: a transistor short circuit check operation including: an upper short circuit check operation for checking for a short circuit of the upper transistor in a state where the second main electrode is pulled down by the second main electrode pull-down switch; and a lower short circuit check operation for checking for a short circuit of the lower transistor in a state where the second main electrode is pulled up by the second main electrode pull-up switch; a transistor open circuit check operation including: an upper open circuit check operation for checking for an open circuit of the upper transistor in the state where the second main electrode is pulled down by the second main electrode pull-down switch; and a lower open circuit check operation for checking for an open circuit of the lower transistor in the state where the second main electrode is pulled up by the second main electrode pull-up switch; a short-to-power check operation for checking for a short-to-power of the motor in the state where the second main electrode is pulled down by the second main electrode pull-down switch; a ground fault check operation for checking for a ground fault of the motor in the state where the second main electrode is pulled up by the second main electrode pull-up switch; and a motor relay check operation for checking for a short circuit and an open circuit of the motor relay in the state where the second main electrode is pulled down by the second main electrode pull-down switch (second configuration).

Preferably, in the second configuration described above, the motor drive device further includes: a first main electrode pull-down switch (60) configured to be able to pull down the first main electrode; and a power supply relay control unit (2) configured to control an on/off state of a power supply relay (M5,M6) arranged between the first main electrode and an application end of the power supply voltage, the check performance unit is configured to check for a short circuit and an open circuit of the power supply relay in a state where the first main electrode pull-down switch is brought into an on state and the checking for a short circuit and an open circuit of the power supply relay is performed before the transistor short circuit check operation (third configuration).

Preferably, in the third configuration described above, the on-resistance value of the first main electrode pull-down switch is higher than each of on-resistance values of the upper transistor and the lower transistor (fourth configuration).

Preferably, in the third or fourth configuration described above, the motor drive device further includes: a first main electrode pull-down resistor (80) configured to be connected in series to the first main electrode pull-down switch (fifth configuration).

Preferably, in the fifth configuration described above, the first main electrode pull-down resistor is configured to include a plurality of resistor elements connected in series (sixth configuration).

Preferably, in any one of the third to sixth configurations described above, the power supply relay includes: a first N-channel MOSFET (M5) that includes a drain connected to the application end of the power supply voltage; and a second N-channel MOSFET (M6) that includes a source connected to a source of the first N-channel MOSFET and a drain connected to the first main electrode, a first end of a first resistor (R7 and R8) that is provided according to the first N-channel MOSFET and the second N-channel MOSFET is connectable to an output end of a charge pump (2) serving as the power supply relay control unit via an external terminal (VCPH terminal) and a first end of a second resistor (R5 and R6) connected between a gate and a source of the first N-channel MOSFET and between a gate and a source of the second N-channel MOSFET is connectable to a second end of the first resistor (seventh configuration).

Preferably, in any one of the third to seventh configurations described above, the check performance unit is capable of performing the checking for a short circuit and an open circuit of the power supply relay, the transistor short circuit check operation, the short-to-ground check operation for the motor and the checking for a short circuit and an open circuit of the motor relay in this order (eighth configuration).

Preferably, in any one of the first to eighth configurations described above, the on-resistance value of the second main electrode pull-down switch is higher than each of on-resistance values of the upper transistor and the lower transistor, and the on-resistance value of the second main electrode pull-up switch is higher than each of the on-resistance values of the upper transistor and the lower transistor (ninth configuration).

Preferably, in the ninth configuration described above, the check performance unit is configured to perform the checking in a state where the motor is connected to the node (tenth configuration).

Preferably, in any one of the first to tenth configurations described above, the motor drive device further includes: at least one of a second main electrode pull-down resistor (81, 82 and 83) connected in series to the second main electrode pull-down switch and a second main electrode pull-up resistor (71, 72 and 73) connected in series to the second main electrode pull-up switch (eleventh configuration).

Preferably, in the eleventh configuration described above, the at least one of the second main electrode pull-down resistor and the second main electrode pull-up resistor are configured to include a plurality of resistor elements connected in series (twelfth configuration).

Preferably, in any one of the first to twelfth configurations described above, each of a plurality of motor relays each being the motor relay is connectable between each of a plurality of input ends provided in the motor and the node in each of a plurality of half-bridges each being the half-bridge, and when a short-to-power and a ground fault of the motor are checked for, all the plurality of motor relays are brought into an on state (thirteenth configuration).

Preferably, in any one of the first to thirteenth configurations described above, each of three or more motor relays each being the motor relay is connectable between each of three or more input ends provided in the motor and the node in each of three or more half-bridges each being the half-bridge, and when a short circuit of the motor relay is checked for, the motor relay to be checked is brought into an off state, and the remaining motor relays are brought into an on state (fourteenth configuration).

Preferably, in any one of the first to fourteenth configurations described above, each of three or more motor relays each being the motor relay is connectable between each of three or more input ends provided in the motor and the node in each of three or more half-bridges each being the half-bridge, and when an open circuit of the motor relay is checked for, all the three or more motor relays are brought into an on state (fifteenth configuration).

A motor system (100) according to an aspect of the present disclosure includes: the motor drive device (1) in any one of the first to fifteenth configurations described above; and a motor (10) configured to be drivable by the motor drive device (sixteenth configuration).

A vehicle (X) according to an aspect of the present disclosure includes: the motor system in the sixteenth configuration (seventeenth configuration).

### INDUSTRIAL APPLICABILITY

For example, the present disclosure can be utilized for in-vehicle motor systems.

### LIST OF REFERENCE SYMBOLS

1 motor drive device
1HB first half-bridge
2HB second half-bridge
3HB third half-bridge
2 charge pump
3 control logic unit
10 motor
41 to 49 pre-driver
51 first pull-up switch
52 second pull-up switch
53 third pull-up switch
60 pull-down switch
61 first pull-down switch
62 second pull-down switch
63 third pull-down switch
71 first pull-up resistor
72 second pull-up resistor
73 third pull-up resistor
80 pull-down resistor
81 first pull-down resistor
82 second pull-down resistor
83 third pull-down resistor
90 to 93 comparator
100 motor system
C5, C6 capacitor
D5, D6 diode
L1 first coil
L2 second coil
L3 third coil
M1 first upper transistor
M2 first lower transistor
M3 second upper transistor
M4 second lower transistor
M5 first power supply relay
M6 second power supply relay
M7 third upper transistor
M8 third lower transistor
M9 first motor relay
M10 second motor relay
M11 third motor relay
R5, R6 second resistor
R7, R8 first resistor
Rsh1 first shunt resistor
Rsh2 second shunt resistor
Rsh3 third shunt resistor
X vehicle

1. A motor drive device configured to drive a motor using at least one half-bridge which includes an upper transistor and a lower transistor and in which the motor is connectable to a node where the upper transistor and the lower transistor are connected, the motor drive device comprising:
at least one of a second main electrode pull-down switch configured to be able to pull down a second main electrode corresponding to the node in the upper transistor including a first main electrode configured to be able to apply a power supply voltage and a second main electrode pull-up switch configured to be able to pull up the second main electrode;
a check performance unit configured to perform an abnormality check operation for at least one of the upper transistor, the lower transistor and the motor in a state where the second main electrode is pulled up or pulled down by bringing one of the second main electrode pull-down switch and the second main electrode pull-up switch into an on state; and
a control circuit configured to control a combination of on/off states of the upper transistor, the lower transistor and a motor relay connected to the motor,
wherein the check performance unit is configured to check, at startup, for at least one of a short circuit and an open circuit of the upper transistor, a short circuit and an open circuit of the lower transistor, a short-to-power and a ground fault of the motor and a short circuit and an open circuit of the motor relay.

2. The motor drive device according to claim 1,
wherein the check performance unit is configured to identify an abnormality by performing, in a following order:
a transistor short circuit check operation including: an upper short circuit check operation for checking for a short circuit of the upper transistor in a state where the second main electrode is pulled down by the second main electrode pull-down switch; and a lower short circuit check operation for checking for a short circuit of the lower transistor in a state where the second main electrode is pulled up by the second main electrode pull-up switch;
a transistor open circuit check operation including: an upper open circuit check operation for checking for an open circuit of the upper transistor in the state where the second main electrode is pulled down by the second main electrode pull-down switch; and a lower open circuit check operation for checking for an open circuit of the lower transistor in the state where the second main electrode is pulled up by the second main electrode pull-up switch;
a short-to-power check operation for checking for a short-to-power of the motor in the state where the second main electrode is pulled down by the second main electrode pull-down switch;
a ground fault check operation for checking for a ground fault of the motor in the state where the second main electrode is pulled up by the second main electrode pull-up switch; and
a motor relay check operation for checking for a short circuit and an open circuit of the motor relay in the state where the second main electrode is pulled down by the second main electrode pull-down switch.

3. The motor drive device according to claim 2 further comprising:
a first main electrode pull-down switch configured to be able to pull down the first main electrode; and
a power supply relay control unit configured to control an on/off state of a power supply relay arranged between the first main electrode and an application end of the power supply voltage,
wherein the check performance unit is configured to check for a short circuit and an open circuit of the power supply relay in a state where the first main electrode pull-down switch is brought into an on state, and
the checking for a short circuit and an open circuit of the power supply relay is performed before the transistor short circuit check operation.

4. The motor drive device according to claim 3,
wherein an on-resistance value of the first main electrode pull-down switch is higher than each of on-resistance values of the upper transistor and the lower transistor.

5. The motor drive device according to claim 3 further comprising:
a first main electrode pull-down resistor configured to be connected in series to the first main electrode pull-down switch.

6. The motor drive device according to claim 5,
wherein the first main electrode pull-down resistor is configured to include a plurality of resistor elements connected in series.

7. The motor drive device according to claim 3,
wherein the power supply relay includes:
a first N-channel MOSFET that includes a drain connected to the application end of the power supply voltage; and
a second N-channel MOSFET that includes a source connected to a source of the first N-channel MOSFET and a drain connected to the first main electrode,
a first end of a first resistor that is provided according to the first N-channel MOSFET and the second N-channel MOSFET is connectable to an output end of a charge pump serving as the power supply relay control unit via an external terminal and
a first end of a second resistor connected between a gate and a source of the first N-channel MOSFET and between a gate and a source of the second N-channel MOSFET is connectable to a second end of the first resistor.

8. The motor drive device according to claim 3,
wherein the check performance unit is capable of performing the checking for a short circuit and an open circuit of the power supply relay, the transistor short circuit check operation, the short-to-ground check operation for the motor and the checking for a short circuit and an open circuit of the motor relay in this order.

9. The motor drive device according to claim 1,
wherein an on-resistance value of the second main electrode pull-down switch is higher than each of on-resistance values of the upper transistor and the lower transistor, and
an on-resistance value of the second main electrode pull-up switch is higher than each of the on-resistance values of the upper transistor and the lower transistor.

10. The motor drive device according to claim 9,
wherein the check performance unit is configured to perform the checking in a state where the motor is connected to the node.

11. The motor drive device according to claim 1 further comprising:
at least one of a second main electrode pull-down resistor connected in series to the second main electrode pull-down switch and a second main electrode pull-up resistor connected in series to the second main electrode pull-up switch.

12. The motor drive device according to claim 11,
wherein the at least one of the second main electrode pull-down resistor and the second main electrode pull-up resistor are configured to include a plurality of resistor elements connected in series.

13. The motor drive device according to claim 1,
wherein each of a plurality of motor relays each being the motor relay is connectable between each of a plurality of input ends provided in the motor and the node in each of a plurality of half-bridges each being the half-bridge, and
when a short-to-power and a ground fault of the motor are checked for, all the plurality of motor relays are brought into an on state.

14. The motor drive device according to claim 1,
wherein each of three or more motor relays each being the motor relay is connectable between each of three or more input ends provided in the motor and the node in each of three or more half-bridges each being the half-bridge, and
when a short circuit of the motor relay is checked for, the motor relay to be checked is brought into an off state, and the remaining motor relays are brought into an on state.

15. The motor drive device according to claim 1,
wherein each of three or more motor relays each being the motor relay is connectable between each of three or more input ends provided in the motor and the node in each of three or more half-bridges each being the half-bridge, and
when an open circuit of the motor relay is checked for, all the three or more motor relays are brought into an on state.

16. A motor system comprising:
the motor drive device according to claim 1; and
a motor configured to be drivable by the motor drive device.

17. A vehicle comprising:
the motor system according to claim 16.
